(19) United States
(12) Patent Application Publication
(10) Pub. No.: US 2023/0342805 A1
(43) Pub. Date: Oct. 26, 2023

(54) DIGITAL CURRENCY PAYMENT METHOD AND SYSTEM

(71) Applicant: NAVER WEBTOON LTD., Seongnam-si (KR)

(72) Inventors: Hyo Jung KIM, Seongnam-si (KR); Da Young KIM, Seongnam-si (KR); Yeon Ju CHA, Seongnam-si (KR); Choon Hae LEE, Seongnam-si (KR); Ji Hoon HA, Seongnam-si (KR); Seung Hwan KIM, Seongnam-si (KR); Ki Hyun PARK, Seongnam-si (KR); Chang Min JEON, Seongnam-si (KR); Se Jin CHA, Seongnam-si (KR); Jae Han YOON, Seongnam-si (KR); Yun Yeon CHOI, Seongnam-si (KR)

(21) Appl. No.: 18/342,925

(22) Filed: Jun. 28, 2023

Related U.S. Application Data
(63) Continuation of application No. PCT/KR2022/002338, filed on Feb. 17, 2022.

(30) Foreign Application Priority Data
Feb. 17, 2021 (KR) 10-2021-0021473

(51) Int. Cl. G06Q 30/0207; G06Q 20/06; G06Q 20/40; G06Q 30/0226

(52) U.S. Cl. CPC G06Q 30/0215; G06Q 20/06; G06Q 20/407; G06Q 30/0226

(57) ABSTRACT

A digital currency payment method for performing a payment related to digital currency used in contents viewing includes monitoring occurrence of a payment event related to a preset payment condition for purchase of the digital currency, in relation to a user account; starting an electronic payment process for purchase of the digital currency with respect to the user account when the payment event has occurred at the user account as a monitoring result; and supplying the digital currency to the user account when the purchase of the digital currency has been completed through the electronic payment process.

### CROSS-REFERENCE TO RELATED APPLICATIONS

This is a continuation application of International Application No. PCT/KR2022/002338, filed Feb. 17, 2022, which claims the benefit of Korean Patent Application No. 10-2021-0021473, filed Feb. 17, 2021.

### BACKGROUND OF THE INVENTION

### Field of Invention

The present invention relates to a digital currency payment method and system, the digital currency being used in contents viewing.

### Description of Related Art

As technologies develop, a utilization degree of digital devices is increased. Especially, electronic devices (e.g., smartphones, tablet PC, etc.) are provided with various functions such as web surfing, listening to music and video contents viewing, using the Internet, as well as a communication function such as voice calls or text messages.

Owing to such popularization of electronic devices, a contents industry shows a remarkable growing trend. Contents mean various types of information provided through the Internet or computer communications, etc. For instance, contents may include webtoon, web novels, music, e-books, stories, moving images, TV program images, pictures, etc.

A representative example of contents which are being actively consumed is a webtoon. The webtoon means a cartoon uploaded and distributed through an internet communication network, and is a compound word of web and cartoon.

As consumption of webtoon is steadily increased, various providers (or webtoon-related service providers) are developing various services so that many consumers can be interested in and consume webtoons. As an example, various providers (or webtoon-related service providers) provide an amount of webtoon corresponding to one book to consumers by dividing it into a plurality of episodes, and induce continuous consumption of the episodes.

As another example, Korean Laid-Open Patent No. 10-2015-0085195 (a method and system for providing animation effect-applied webtoons to a user terminal) provides consumers with webtoons to which animation effects have been applied, and proposes a method to enhance a consumer's understanding of webtoons.

In order to induce consumers' consumption and interests in contents, various research is actively ongoing. However, there still exists a need to attract a larger number of consumers by enhancing consumers' purchase intentions for contents, and to maintain continuous consumption of contents.

### BRIEF SUMMARY OF THE INVENTION

The present invention relates to a payment method and system for digital currency used in contents viewing, capable of allowing contents consumption to be continuously performed.

More specifically, the present invention relates to a payment method and system for digital currency used in contents viewing, capable of providing a new payment method for digital currency, and capable of allowing contents consumption to be continuously performed.

Further, the present invention relates to a payment method and system for digital currency used in contents viewing, capable of providing a new type of rewards for digital currency, and capable of allowing a payment for digital currency to be continuously performed.

Further, the present invention relates to a payment method and system for digital currency used in contents viewing, capable of allowing a user to consume contents more economically.

In order to achieve these and other advantages and in accordance with the purpose of this specification, there is provided a digital currency payment method for performing a payment related to digital currency used in contents viewing, the method comprising: monitoring occurrence of a payment event related to a preset payment condition for purchase of the digital currency, in relation to a user account; starting an electronic payment process for purchase of the digital currency with respect to the user account when the payment event has occurred at the user account as a monitoring result; and supplying the digital currency having been purchased to the user account when the purchase of the digital currency has been completed through the electronic payment process, wherein an amount of the digital currency supplied to the user account is changed according to a completion frequency of the electronic payment process for purchase of the digital currency at the user account.

Further, there is provided a digital currency payment system for payment of digital currency used in contents viewing, the system comprising: a storage unit configured to store user information related to a user account; and a controller configured to monitor occurrence of a payment event related to a preset payment condition for purchase of the digital currency, in relation to the user account, wherein the controller starts an electronic payment process for purchase of the digital currency with respect to the user account based on the user information, in a case that the payment event has occurred at the user account as a monitoring result, wherein the controller supplies the digital currency having been purchased to the user account when the purchase of the digital currency has been completed through the electronic payment process, and wherein an amount of the digital currency supplied to the user account is changed according to a completion frequency of the electronic payment process for purchase of the digital currency at the user account.

Further, there is provided a program storable in a computer-readable recording medium, the program being executed in an electronic device by one or more processors, and comprising commands configured to: monitor occurrence of a payment event related to a preset payment condition for purchase of digital currency, in relation to a user account; start an electronic payment process for purchase of the digital currency with respect to the user account, in a case that the payment event has occurred at the user account as a monitoring result; and supply the digital currency having been purchased to the user account when purchase of the digital currency has been completed through the electronic payment process, wherein an amount of the digital currency supplied to the user account is changed according to a completion frequency of the electronic payment process for purchase of the digital currency at the user account.

As aforementioned, in the digital currency payment method and system of the present invention, whenever a payment event related to payment of digital currency occurs, a payment for purchase of digital currency is started. This may allow a payment for digital currency to be continuously performed. As a result, as purchase of digital currency used in contents viewing is continuously performed, consumption of contents may be continuously performed.

Further, at the time of viewing contents, a user convenience in that he or she needs not perform an electronic payment for purchase of digital currency every time may be enhanced. And the user may freely view contents by using digital currency owned at any time.

That is, in the digital currency payment method and system of the present invention, an electronic payment process is automatically started based on the occurrence of a payment event related to a payment condition. This may provide a user convenience that he or she need not additionally perform an electronic payment. Further, through a payment method for digital currency used in contents viewing, capable of allowing contents viewing to be continuously performed, a contents provider may effectively induce contents consumption by a consumer and may ensure the consumer's continuous contents consumption. This may prevent the consumer from leaving.

Further, in the present invention, a different amount of digital currency is supplied to a user account, according to a frequency (the number of times) of completion of an electronic payment process for purchase of digital currency. This may allow a user to be provided with a reward for purchase of digital currency, and to consume contents economically. A contents provider may prevent a user from halfway cancelling an automatic payment, thereby effectively managing members.

### BRIEF DESCRIPTION OF THE DRAWINGS

FIG. 1 is a block diagram for explaining a digital currency payment method and system according to the present invention.

FIG. 2 is a conceptual view for explaining a user environment to which contents are provided, in an electronic digital currency payment method and system for contents usage according to the present invention.

FIG. 3 is a flowchart for explaining a digital currency payment method according to the present invention.

FIG. 4 is a conceptual view for explaining a first payment type among a plurality of payment types, in an electronic digital currency payment method and system for contents usage according to the present invention.

FIG. 5 is a conceptual view for explaining a second payment type among a plurality of payment types, in an electronic digital currency payment method and system for contents usage according to the present invention.

FIGS. 6 and 7 are conceptual views for explaining a digital currency payment method according to the present invention.

FIG. 8 is a conceptual view for explaining matching information according to the present invention.

FIGS. 9 to 11 are conceptual views for explaining reward digital currency according to the present invention.

FIGS. 12 and 13 are conceptual views for explaining a payment history of a user account according to the present invention.

FIG. 14 is a conceptual view for explaining a valid period of digital currency according to the present invention.

FIGS. 15 to 18 are conceptual views for explaining history information according to the present invention.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, terms such as “module” and “unit” may be used to refer to elements or components. Use of such terms herein is merely intended to facilitate description of the specification. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of features, numbers, steps, functions, several components, or combinations thereof, disclosed in the specification, and it is also understood that greater or fewer features, numbers, steps, functions, several components, or combinations thereof may likewise be utilized.

The present invention relates to a payment method and system for digital currency used in contents viewing, and may provide an environment which allows contents consumption to be continuously performed, through a payment of digital currency.

A digital currency payment system explained in the present invention is a system including a contents providing system or connected thereto, and digital currency purchased by the digital currency payment system may be utilized to view contents provided from a contents providing system.

In the present invention, a method to purchase digital currency will be explained by using the term of “digital currency payment system.” However, an electronic payment function provided from the digital currency payment system may be one function provided from “contents providing system.” In this case, it will be apparent to those skilled in the art that the “digital currency payment system” may be referred to as the “contents providing system.”

Further, the digital currency payment system may be referred to as an “electronic payment system.” The digital currency payment system may supply digital currency to a user account, based on an electronic payment for purchase of digital currency and a payment completion.

“Contents” explained in the present invention may mean various types of information provided through the Internet or computer communications. Types of contents which may be applicable to the present invention may greatly vary. For instance, at least one of contents such as webtoons, web novels, music, e-books, stories, moving images, TV program images and pictures may be provided in the present invention.

Hereinafter, contents corresponding to a webtoon will be explained for convenience. Here, webtoon is a compound word of web and cartoon, and means a cartoon or a comic provided through an internet communication network.

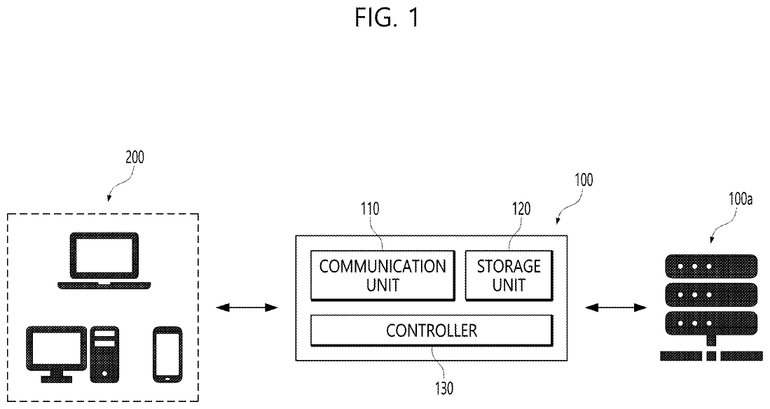

The contents corresponding to a webtoon (hereinafter, will be referred to as “webtoon contents”) may be provided onto an electronic device 200 through an electronic digital currency payment method and system for contents usage according to the present invention. Thus, a user may use webtoon contents provided through the electronic digital currency payment method and system for contents usage through the electronic device 200 shown in FIG. 1.

In the present invention, webtoon contents may be comprised of a plurality of sub contents. The plurality of sub contents may constitute series of webtoon contents. Here, the series may mean consecutive sections of contents.

In the present invention, for prevention of confusion between webtoon contents and sub contents, “sub contents” will be referred to as “episodes.” Such sub contents and episodes are terms used for a conceptual distinguishment, and it will be apparent to those skilled in the art that all of them correspond to “contents.”

In this case, webtoon contents may be comprised of a plurality of episodes, and the plurality of episodes may be the same or at least-partially different product types. Here, the product type of an episode may be either a “free product type” or a “charged product type.”

An episode having a “free product type” may mean an episode that a user can directly use without a payment such as digital currency, coupons or a viewing right (or a usage right) in order to view (or use) an episode. In contrast, an episode having a “charged product type” may mean an episode that a user can use after a payment such as digital currency, coupons or a viewing right (or a usage right) in order to view (or use) an episode. That is, contents provided in the present invention may be comprised of at least one episode, and each episode may be either a charged product type which allows viewing through a payment of the digital currency, or a free product type which allows viewing without a payment of the digital currency.

Here, the preset time may be variously set, and whether the preset time has lapsed or not may be counted based on an uploaded date or the time of the charged product type contents. For instance, a specific episode of a charged product type may be converted into free product type contents after 3 days based on an uploaded date of the specific episode on a contents providing service.

In the digital currency payment system according to the present invention, as a payment method for digital currency used to view a charged product type episode, when a user's request to view a charged product type episode is received, digital currency retained (kept) at a user account may be subtracted and the charged product type episode may be provided to an electronic device of the user.

Meanwhile, an electronic device 200 means an electronic device 200 of a user, and has no limitation in its type, only that it output webtoon contents provided through a contents providing system of the present invention.

As shown in FIG. 1, the electronic device 200 may be a portable phone, a smart phone, a notebook computer, a laptop computer, a slate PC, a tablet PC, an ultrabook, a desktop computer, a digital broadcasting terminal, a personal digital assistant (PDA), a portable multimedia player (PMP), a navigation, a wearable device (e.g., a smartwatch), a glass type terminal (a smart glass), a head mounted display (HMD), etc.

In the present invention, “digital currency” is currency used in a digital manner (stored in a computer for usage, or used on a network), and may be referred to as “cyber money.” Such digital currency may mean currency having a monetary value stored in an electronic manner, i.e., electronically.

Digital currency may exist by being stored in an electronic manner on a payment system 100 according to the present invention, or a server associated therewith.

Digital currency may be stored by being interworked with a user account. That is, a predetermined number of units of digital currency purchased by a user may exist by being interworked with a user account.

Such digital currency is utilized for economic consumption activities, and may include social currency, internet coupons, mobile coupons, game money and so on, as an example.

Digital currency may be used at different places based on its issuance provider. For instance, digital currency issued by company A may be used only at a service platform provided by company A (e.g., a webtoon service, a shopping mall, etc. operated by company A). If there are a plurality of service platforms provided by company A, the digital currency issued by company A may be commonly used at the plurality of service platforms by a policy of company A.

For instance, digital currency issued by company A may be commonly used at a plurality of different service platforms such as a webtoon service platform, a moving image providing platform and an OTT service platform.

Such digital currency may be commonly used among service platforms of different providers by their cooperation (tie-up).

Further, digital currency may be referred to by various terms, and may be named by a provider. For instance, the digital currency may be called as an arbitrary name such as soybeans, beans, acorns and corns. In the descriptions and the drawings of the present invention, such digital currency will be referred to as “cookies.” Thus, in the present invention, the term of “cookies” will be used together with the term of “digital currency,” and the term of “cookies” will be understood as digital currency.

Digital currency may be purchased by an electronic settlement (payment).

The electronic settlement (payment) explained in the present invention means a user's (or a consumer's) payment for purchase of a product or a service, by using an electronic device 200 to which a tradable program for currency having a monetary value or a function is connected.

Such an electronic payment may be understood as a meaning which includes online card payment, point payment, account transfer, etc.

Here, a product may mean digital currency in the present invention. In the present invention, an electronic payment may be used together with “payment.”

In the present invention, “purchase of digital currency through an electronic payment” may be expressed as “charging of digital currency.” That is, a user may “purchase” or “charge” digital currency by an electronic payment. Such digital currency purchased or charged may exist by being interworked with a user account.

Digital currency of the present invention may have a plurality of attributes or types.

The attributes or types of digital currency may be categorized according to whether digital currency has been “purchased” through an electronic payment.

More specifically, digital currency having a first attribute (or a first type) among a plurality of attributes is digital currency purchased through an electronic payment. In the present invention, such digital currency obtained by a purchase action may be referred to as “purchase digital currency” or “purchased digital currency.” “Purchase digital currency” may mean digital currency which is to be provided to a user account, in correspondence to an electronic payment.

Further, digital currency having a second attribute (or a second type) among a plurality of attributes is digital currency which is to be provided to a user account separately from a purchase behavior of digital currency through an electronic payment, and may be referred to as “bonus digital currency.”

Such “bonus digital currency” may mean digital currency which is to be provided to a user account separately from a purchase behavior of digital currency through an electronic payment, in the aspect of a user's benefit (compensation or reward). Such bonus digital currency may be used together with the terms of “additional digital currency,” “reward digital currency,” “compensation digital currency,” etc.

In the present invention, a proper amount of bonus digital currency may be supplied for continuous purchase of digital currency.

An amount explained in the present invention is a value indicating the amount of digital currency. When there exists a number of units of digital currency, the amount may mean the amount according to the unit. In the present invention, the “amount” may be used together with the “number.”

In the present invention, the number of units of digital currency provided to a user account in correspondence to a price payment through an electronic manner is referred to as a “purchase amount.” In the present invention, the “purchase amount” may be used together with a “charging amount.”

Further, in the present invention, the number of units of digital currency provided to a user account separately from a price payment is referred to as an “additional amount.” In the present invention, the “additional amount” may be used together with a “bonus amount,” a “reward amount” or a “compensation amount.”

Meanwhile, in the present invention, an electronic payment for purchase of digital currency may have a plurality of electronic payment types (or methods). A first payment method (or a first electronic payment method) may be understood as a one-time payment method, which may mean a payment method to purchase digital currency only when there is a user's request for purchase of digital currency.

In the case of the first payment method, after an electronic payment process is started and completed by a user, an additional electronic payment is not performed until the user requests for an additional payment, because the first payment method has a one-time payment attribute.

A second payment method may be understood as an automatic payment method, which may mean that an electronic payment process for purchase of digital currency is started without a user's request. According to the second payment method, when a pre-registered electronic payment means (e.g., a credit card, a bank account) is valid, purchase of digital currency may be performed based on start of an electronic payment process even if there is not a user's request.

In the case of the second payment method, a payment condition may be registered to the user account, and the digital currency payment system 100 may perform (or start) an electronic payment process based on the occurrence of a payment event which satisfies the payment condition registered to the user account. Monitoring such a payment event and performing an electronic payment process according to the payment event may be performed by the digital currency payment system 100 of the present invention without a user's intervention. The second payment method may be referred to as “automatic payment.” The “automatic payment” may mean that payment for purchase of digital currency is performed under control of the digital currency payment system 100 according to a user's consent. In the present invention, “automatic payment” and “automatic charging” may be used together.

In the present invention, continuous purchase of digital currency is induced through such a second payment method, and the following descriptions will be explained with a focus on the second payment method.

Meanwhile, an electronic payment may be performed a plurality of times at a user account, and the order may be counted whenever an electronic payment is performed. For instance, if an electronic payment is performed again after eight electronic payments are performed, this may be a ninth electronic payment.

In the present invention, in a case where electronic payments for purchase of digital currency are performed repeatedly (or a plurality of times) at a user account, the order of a payment (or the sequence of a payment) may be referred to as “the number of times.” A first payment may mean a payment performed firstly or for the first time after a preset reference time at a user account.

The number of times of payment may be counted as a first payment, a second payment, a third payment, etc. whenever payments are performed. In the present invention, “the number of times” may be used together with “frequency” or “order.”

Whenever an electronic payment is performed, the digital currency payment system 100 of the present invention may perform counting for the number of times of the electronic payment. Such counting may be performed when an electronic payment according to a second electronic payment method (automatic payment method) is performed.

Performing counting means doing counting for the number of times of a payment.

In the present invention, the second payment method corresponding to an automatic payment may include “a plurality of payment types” related to purchase of digital currency. The digital currency payment system 100 may receive selection information for selecting a specific payment type among a plurality of payment types, from a user account.

“A plurality of payment types” explained in the present invention define when and how a payment (especially, a second type of payment (automatic payment)) is to be performed, which may mean defining a condition which generates a payment event with respect to an automatic payment.

In the present invention, a plurality of payment types are explained as “first payment type” and “second payment type” as an example. However, the present invention is not limited to this. More detailed descriptions will be explained later.

In the present invention, “a specific payment type” may mean at least one of the plurality of payment types. More specifically, a specific payment type may mean a payment type specified based on selection information received from a user account.

Further, a factor to determine when and how to perform an electronic payment is referred to as “a payment condition” in the present invention. The “payment condition” may be specified by a user's selection or a provider.

Meanwhile, in the present invention, a “user” may mean a subject who purchases digital currency and consumes (buys or views) webtoon contents. In the present invention, the user may be used together with “consumer,” “user account,” “user's electronic device,” “user electronic device 200,” “subscriber,” “viewer” or “crowd.”

A user may purchase digital currency based on an “account (i.e., a user account)” pre-registered to the digital currency payment system of the present invention, and may consume (buy or view) contents by using the purchased digital currency.

The “account” can be generated through a page associated with the digital currency payment system 100. Alternatively, the “account” can be also generated in at least one system associated with the electronic payment system 100 of the present invention.

Thus, in this specification, all accounts based on the digital currency payment system of the present invention will be referred to as “accounts pre-registered to the digital currency payment system of the present invention” without a division of a system to which an account has been provided.

For understanding of the present invention, a data transmission/reception flow will be explained.

Firstly, information transmission to the digital currency payment system 100 from a user (i), or information transmission to a user from the digital currency payment system 100 (ii) may substantially mean information transmission to the digital currency payment system 100 from an “electronic device 200 logged-in with a user account” (i), or information transmission to an “electronic device 200 logged-in with a user account” from the digital currency payment system 100 (ii).

However, in this specification, they will not be distinguished from each other definitely for convenience of explanations, and will be explained with a subject of a “user account.” For instance, information transmission from an “electronic device 200 logged-in with a user account” (i), or information reception by an “electronic device 200 logged-in with a user account” (ii) will be explained as “information transmission from a user account” (i) or “information reception by a user account” (ii).

Further, a “provider” used in the present invention may mean a subject who operates the digital currency payment system 100. That is, in the present invention, a provider may be understood as the digital currency payment system 100 according to the present invention or a contents providing system.

Hereinafter, a digital currency payment method and system for purchasing digital currency used in contents viewing will be explained in more detail with reference to the attached drawings, based on the above-explained terms. FIG. 1 is a block diagram for explaining a digital currency payment method and system according to the present invention.

As shown in FIG. 1, the digital currency payment system 100 may include at least one of a communication unit 110, a storage unit 120 and a controller 130.

Here, the communication unit 110 may provide (or transmit) contents (hereinafter, “webtoon contents” will be used as an example) onto the electronic device 200 through wired or wireless communications.

Further, the communication unit 110 may transceive (transmit and receive) various data for performing an electronic payment to/from the electronic device 200.

Next, the storage unit 120 may store various information related to provision of webtoon contents and charging of digital currency. The storage unit 120 may include at least one contents server 100a (or contents database (DB)) including a plurality of webtoon contents.

Hereinafter, contents server and contents DB will be referred to as contents server without a division. That is, it is obvious that contents server explained in the present invention may be also understood as contents DB.

Further, the contents server 100a for storing a plurality of webtoon contents may exist as a separate component from the storage unit 120. In this case, the digital currency payment system 100 may provide webtoon contents stored in the contents server 100a to the user's electronic device 200 by controlling the contents server 100a.

Further, the storage unit 120 may store therein information on a user who has subscribed to a service provided from the digital currency payment system of the present invention (e.g., a webtoon providing service). Such user information may include information about a user account (e.g., identification (ID)). A user may use webtoon contents by logging-in a service provided from the digital currency payment system 100 of the present invention, with a user account.

Further, the storage unit 120 may store therein various types of information associated with a user account. For instance, the storage unit 120 may store therein user history information associated with the user's electronic device 200.

Here, the user “history information” may include various information generated from the digital currency payment system 100 of the present invention, such as information on a payment method received from a user account, information on a payment type, information on a payment condition, information on a payment event related to a payment and information on a purchase history of digital currency. In the present invention, the term of “history information” may be used together with a “payment history.”

Next, the controller 130 may perform a series of controls for performing the electronic digital currency payment method of the present invention.

More specifically, the controller 130 may monitor whether a payment event which satisfies a payment condition has occurred at a user account. The controller 130 may perform an electronic payment process for purchasing digital currency with respect to a user account according to a monitoring result. Further, the controller 130 may count the number of times of an electronic payment performed at the user account, and may control the storage unit 120 to store a counting result. The controller 130 may provide bonus digital currency to the user account based on the counting result, and detailed descriptions will be explained hereinafter.

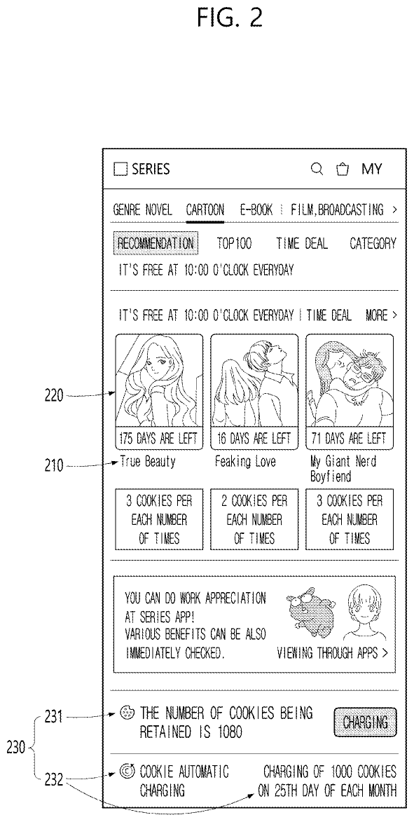

Hereinafter, an electric payment for purchasing digital currency will be explained in more detail with reference to the attached drawings, based on the terms used in the present invention and the configuration of the digital currency payment system 100. FIG. 2 is a conceptual view for explaining a user environment to which contents are provided, in a digital currency payment method and system according to the present invention.

As shown in FIG. 2, the digital currency payment system 100 according to the present invention may provide a user environment for providing webtoon contents. Such a user environment may be provided through an application installed at the electronic device 200, or a webpage accessed through the electronic device 200. Such a user environment may mean a page including visual information provided through a display unit of the electronic device 200, and may be referred to as a graphic user interface.

As shown in FIG. 2, such a user environment may be configured variously, and may be configured to provide contents (e.g., webtoon contents) to a user. For instance, as shown, a page provided to the electronic device 200 may include at least one of i) a description (or a title) 210 about a plurality of contents (e.g., a plurality of webtoon contents), ii) a thumbnail (or a mark) 220 indicating each of webtoon contents, and iii) at least one of information 230 on digital currency required to view each content. A configuration of a screen provided to a page may be modified very greatly.

A user may check webtoon contents and select desired contents for viewing, through a page provided through the electronic device 200.

Herein, if a type of contents selected by a user is a charged product type, the controller 130 may subtract digital currency retained at a user account, and then may provide the charged product type of contents to the user.

More specifically, in a case where a product type of specific contents (e.g., specific episodes) selected by a user is a charged product type, if an item corresponding to specific contents is selected on the electronic device, the controller 130 may determine whether a user account logged-in to the electronic device has a usage right (or a viewing right) required to view (or use) the specific contents.

Here, the determination of a usage right (or a viewing right) may be understood as a determination whether a user account logged-in to the electronic device has a right to use (or view) the specific contents.

Meanwhile, “a user account has a usage right or a viewing right for charged product type of contents” may be understood as “a user account has digital currency, coupons or a viewing right (or a usage right) which can be used (or paid) to use charged product type of contents.”

If charged product type of specific contents are selected, the controller 130 may perform a payment process of i) paying digital currency, ii) using coupons, or iii) using (or subtracting) a viewing right, each retained at the user account.

The controller 130 may provide charged product type of contents, to the user account which has completed a payment for viewing (or using) the charged product type of contents through such a payment process.

In the present invention, “providing contents onto an electronic device” may mean transmitting contents-related information to an electronic device such that contents are output onto the electronic device.

In a case where a free product type of contents are selected from a user, the controller 130 may provide the selected contents to the user's electronic device 200 without determining whether the user has a right to use the contents.

Meanwhile, even in the case of a free product type of contents, the controller 130 may provide the contents only to an electronic device logged-in with a user account pre-registered to the digital currency payment system of the present invention.

For instance, a request to view free product type of contents is received from the electronic device 200, the controller 130 may check whether the electronic device has been logged-in with a user account. After checking that the electronic device 200 has been logged-in with the user account, the controller 130 may provide the free product type of contents onto the electronic device. Here, if the electronic device 200 has not been logged-in with the user account, the controller 130 may perform a process for log-in.

As shown in FIG. 2, in the digital currency payment system according to the present invention, if there is a request to view charged product type of contents, the charged product type of contents may be provided to the user through provision (or subtraction) of digital currency already retained at the user account.

Hereinafter, a method to induce continuous purchase of digital currency will be explained in more detail with reference to the attached drawings, by explaining a digital currency purchasing method through an automatic payment method among digital currency purchasing methods.

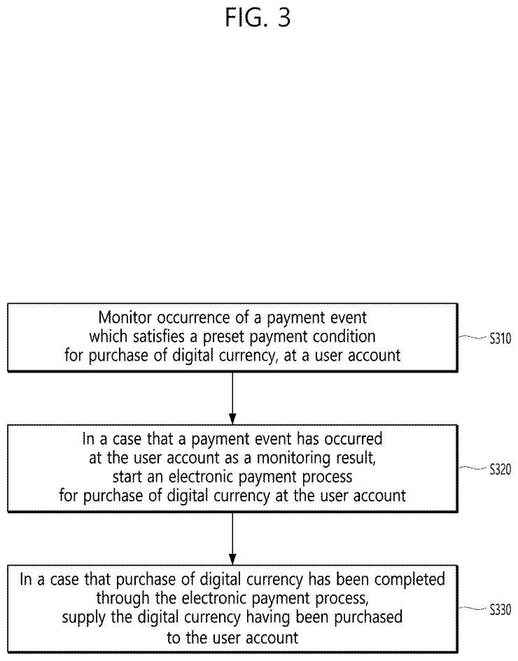

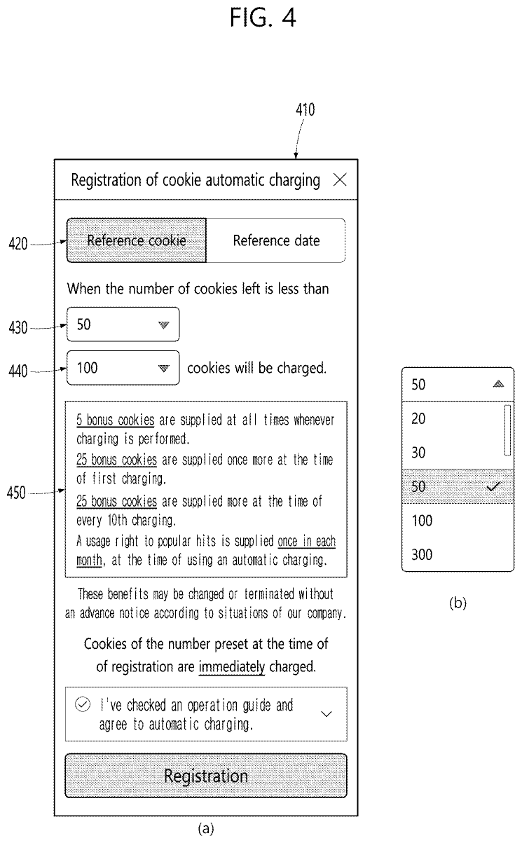

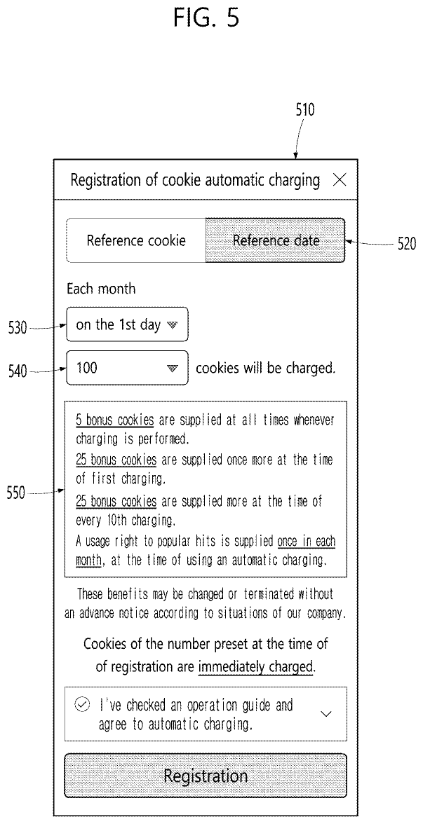

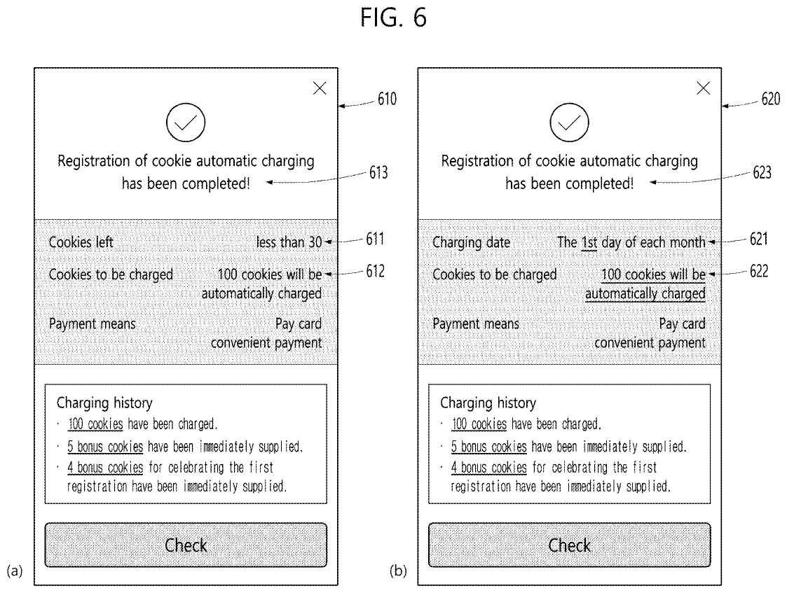

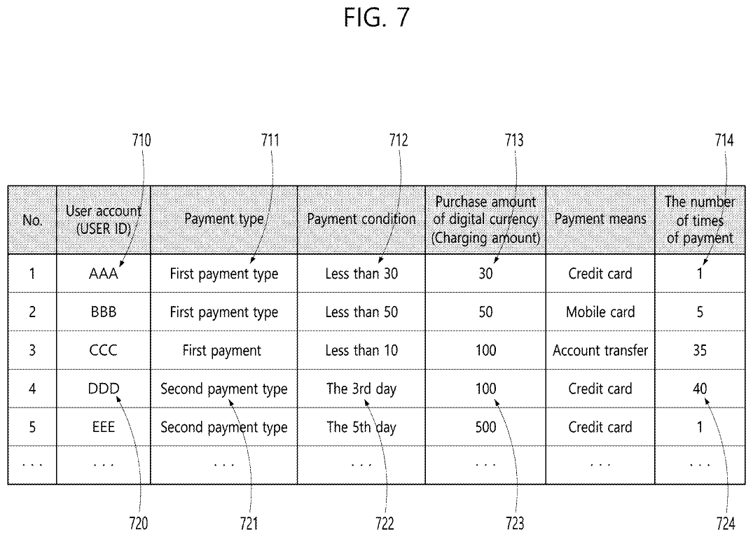

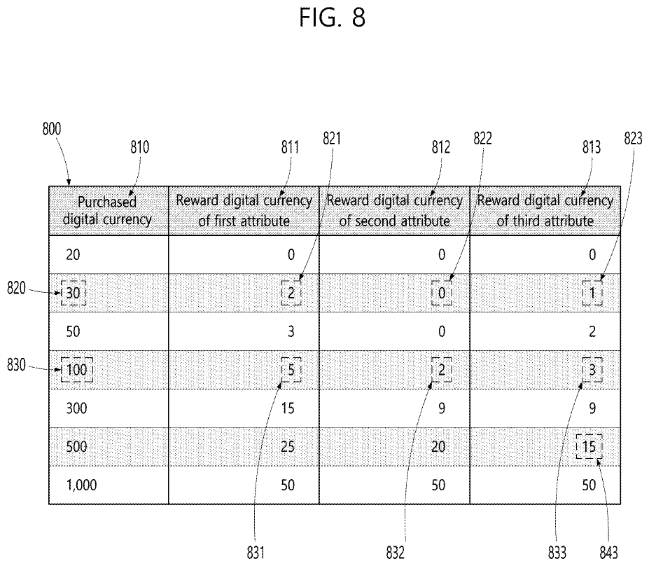

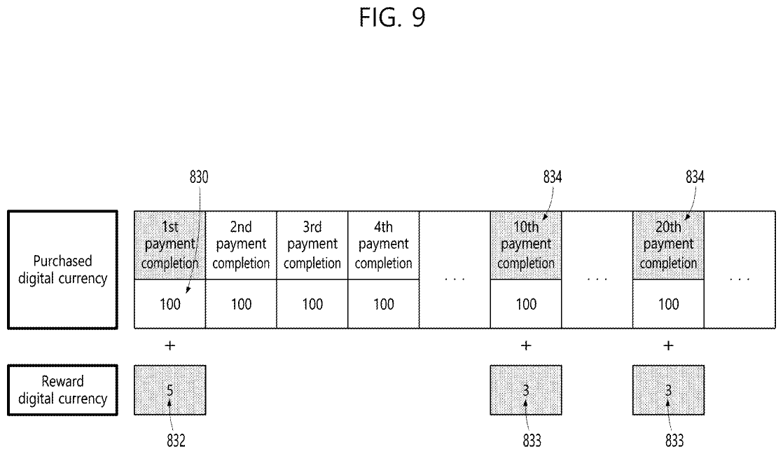

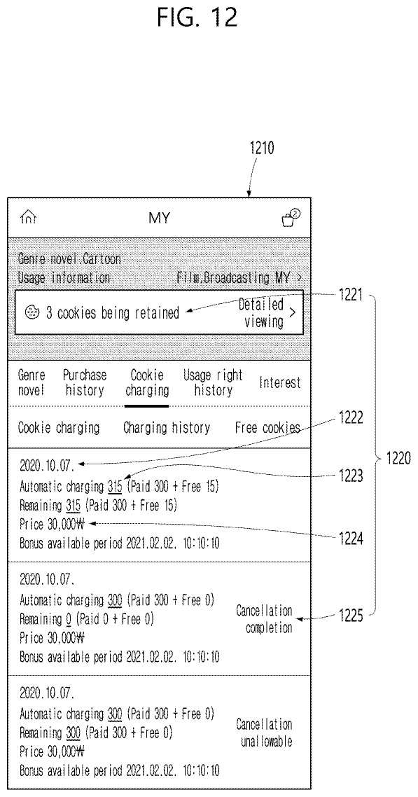

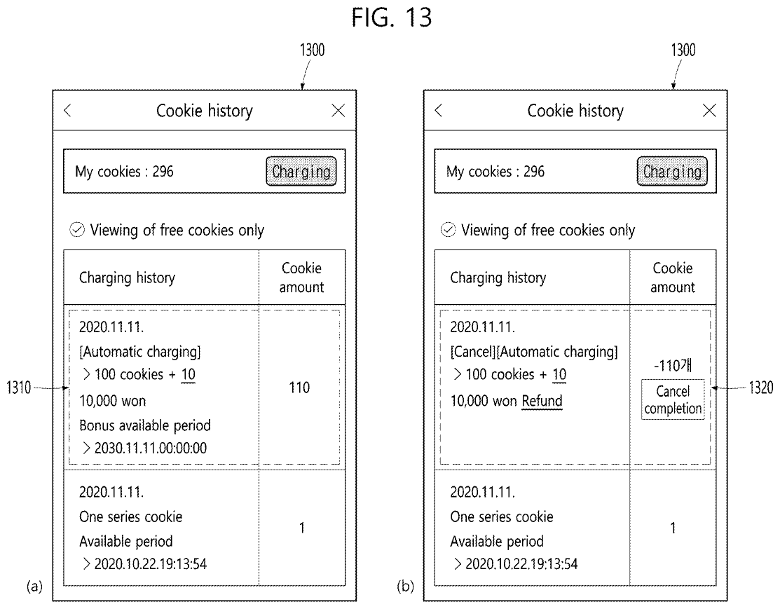

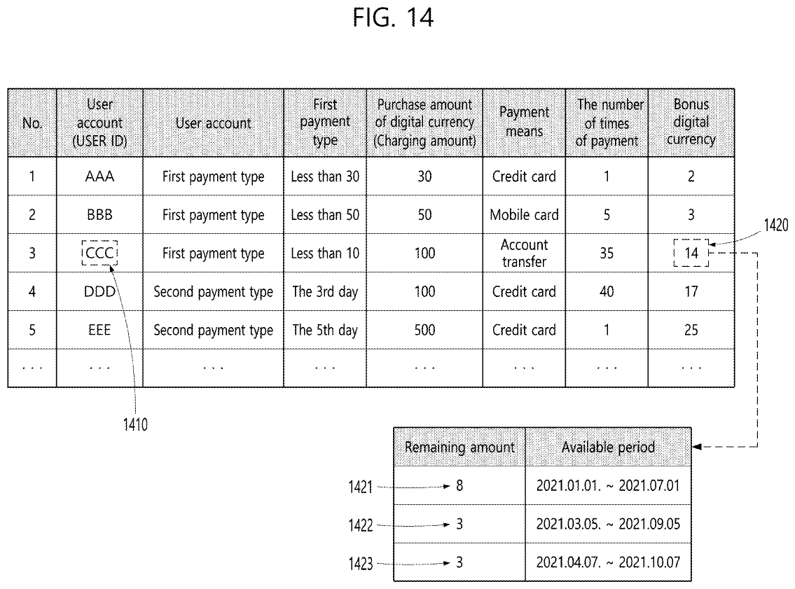

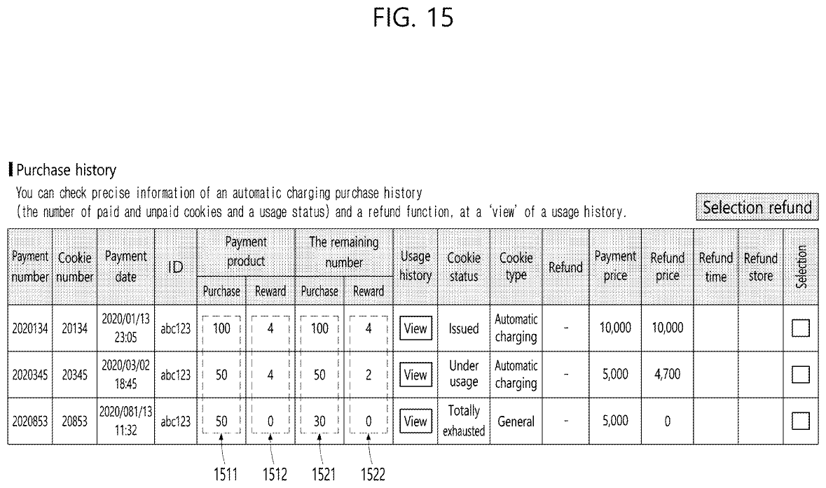

FIG. 3 is a flowchart for explaining a digital currency payment method according to the present invention. FIG. 4 is a conceptual view for explaining a first payment type among a plurality of payment types, in an electronic digital currency payment method and system for contents usage according to the present invention. FIG. 5 is a conceptual view for explaining a second payment type among a plurality of payment types, in an electronic digital currency payment method and system for contents usage according to the present invention. FIGS. 6 and 7 are conceptual views for explaining a digital currency payment method according to the present invention. FIG. 8 is a conceptual view for explaining matching information according to the present invention. FIGS. 9 to 11 are conceptual views for explaining reward digital currency according to the present invention. FIGS. 12 and 13 are conceptual views for explaining a payment history of a user account according to the present invention. FIG. 14 is a conceptual view for explaining a valid period of digital currency according to the present invention. FIGS. 15 to 18 are conceptual views for explaining history information according to the present invention.

Firstly, in a digital currency payment method according to the present invention, whether a payment event which satisfies a preset payment condition has occurred may be monitored (S310).

Such monitoring may be performed in a case where the aforementioned second payment type (automatic payment method) has been set to a user account, for purchase of digital currency. The controller 130 may monitor whether a payment event which satisfies a payment condition for generating an automatic payment has occurred at the user account to which an automatic payment has been registered.

Here, the preset payment condition is a payment condition registered (or interworked) to or with the user account, and the controller 130 may determine whether a payment event which satisfies a payment condition interworked with the user account is generated.

In the present invention, a payment condition is a basis by which a payment event which starts a payment process is generated, and may be differently set (or registered) according to a payment type as aforementioned.

In the present invention, a payment condition registration process may be performed through selection information generated after selecting a specific payment type among a plurality of payment types according to an automatic payment method by the user, and then inputting (or selecting) information on a payment condition related to the specific payment type.

Payment conditions may correspond to a plurality of different payment types, and the plurality of different payment types may be specified as selection information received from the user account.

The selection information may be received through a page of a specific application (e.g., a webtoon contents providing application) associated with the digital currency payment system 100 of the present invention, or a specific webpage (e.g., a webtoon contents providing webpage).

For understanding of the present invention, a method to set or register a payment condition will be explained firstly.

The controller 130 may provide a “charging guide page” for inducing purchase (or charging) of digital currency, onto the user's electronic device 200, in order for digital currency to be purchased through an automatic payment method. Such a charging guide page may be provided only under a preset condition. For instance, a “charging guide page” for inducing charging of digital currency may be provided only when a user firstly executes a specific application or when a user firstly accesses a specific web page.

The charging guide page may be referred to as an “automatic payment registration page” for setting a payment type related to digital currency, or a “charging registration page,” etc.

A user may select a specific payment type among a plurality of different payment types related to an automatic payment method, through a charging registration page.

When a request to provide (connect to or access) a “charging registration page” is received from the user's electronic device 200, the controller 130 may provide the “charging registration page” onto the user's electronic device 200.

The controller 130 may provide information related to the charging registration page to the user's electronic device 200, such that the charging registration page is provided to the user's electronic device 200.

The user's request for providing the charging registration page may be performed through various paths. For instance, the charging registration page may be provided based on a selection for one region among a “charging guide page” outputted onto the electronic device 200. The one region may be a region where a function icon related to provision of the charging registration page has been output.

The controller 130 may output information on a plurality of different payment types related to digital currency, onto the “charging registration page.” In the present invention, through such information, a plurality of different payment types are introduced to a user so that the user may select a specific payment type corresponding to his or her contents consumption pattern, etc.

In the present invention, a plurality of different payment types may be related to different payment conditions. The controller 130 may control an electronic payment process to be started when a payment event which satisfies a payment condition matched with each of a plurality of payment types occurs at the user account.

A plurality of payment types will be explained in more detail. A plurality of payment types may be related to different payment conditions. That is, a plurality of payment types may mean specifying automatic payments with respect to a user account on the basis of specific payments.

The plurality of payment types may be categorized based on various payment conditions. For instance, the plurality of payment types may include i) a first payment type matched with a payment condition related to the amount of digital currency, and ii) a second payment type matched with a payment condition related to a reference date (a specific date, a payment date, etc.).

In the case of the first payment type among the plurality of payment types, a payment process may be started with respect to digital currency retained at the user account. For instance, in the case of the first payment type, the controller 130 may start a payment process when the amount of digital currency retained at the user account does not satisfy a preset reference amount.

Further, in the case of the second payment type, a payment process may be started based on a reference date selected from the user account. In this case, the controller 130 may start a payment process with respect to the user account on each reference date.

In the present invention, a selection for an automatic payment process through a payment type may be received from the user.

As shown in FIGS. 4 and 5, such a user's selection may be received through charging registration pages 410, 510. The charging registration pages 410, 510 may include graphic objects 420, 520 for selecting at least one of a plurality of payment types. The user may specify his or her desired payment type through a selection for a graphic object.

When a specific payment type is selected, the controller 130 may receive information on a payment condition for the specific payment type and amount information of digital currency to be purchased.

Here, the selection information may include at least one of payment condition information and amount information. The controller 130 may register a payment condition corresponding to a specific payment type to a user account, by using selection information received from the user account.

More specifically, the controller 130 may receive payment condition information and amount information corresponding to a payment type, based on a user's selection for a specific payment type among a plurality of payment types. The amount information may mean information which specifies the purchase amount for digital currency.

For instance, as shown in FIG. 4, when the user selects a first payment type, the controller 130 may receive, from the user account, i) information 430 on the minimum amount of digital currency which is a condition (or a payment condition) to start a payment process, and ii) information 440 on the amount of digital currency to be purchased through a payment process.

As shown in FIG. 4(a), when a graphic object 420 corresponding to a first payment type is selected from the user account and selection information is received, the controller 130 may provide, onto the user's electronic device 200, a page corresponding to a graphic user interface (GUI) for inputting a minimum amount 430 (reference amount or reference cookies) of digital currency corresponding to a condition to start a payment process, and ii) an amount 440 of digital currency (e.g., cookies) to be purchased (or to be charged).

When the number of units of digital currency retained by a user is less than a predetermined number, the user may input selection information for charging a predetermined number of units of digital currency, through a page. Selection information selected from the user's electronic device 200 may be transmitted to the digital currency payment system 100. For instance, when the number of cookies (a name of digital currency) retained at the user is less than 50, in the case of charging 100 cookies, the user may select a minimum amount of digital currency as 50 and may select a purchase amount of digital currency as 100. Such selection information may be transmitted to the digital currency payment system 100 of the present invention. The digital currency payment system 100 of the present invention may provide a user environment which allows a user to freely change an amount of digital currency. As shown in FIG. 4(b), a drop-down type of selection environment may be provided. A user may freely select the amount of digital currency as 20, 30, 50, 100, 300, etc. through a drop-down type of selection environment. A drop-down type of list may include items for selecting the amount of digital currency.

An amount unit of chargeable digital currency may be preset. The controller 130 may provide the user with information on a plurality of amount units (20, 30, 50, etc.), and may be provided with an amount unit selected from the user.

The controller 130 may differently recommend information on a minimum amount 430 (reference amount or reference cookies) of digital currency corresponding to a condition to start a payment process, according to an amount of digital currency retained at the user account. The controller 130 may recommend information on a minimum amount of digital currency to the user at a drop-down type of environment, and a recommended amount for the user may be changed according to an amount of digital currency retained at the user account.

Referring to FIG. 4(a), the controller 130 may set information on a minimum amount of digital currency for starting a payment process, to be larger than an amount of digital currency currently retained at the user account. In this case, among a plurality of amount units, the controller 130 may select an amount unit greater than a current amount of digital currency retained at the user account, as a recommendation amount. Also, if there is a plurality of amount units greater than the current amount of digital currency retained at the user account, the controller 130 may select a minimum amount unit among the plurality of amount units as a recommendation amount.

For instance, in a case where a user has 45 units of digital currency and there are amount units of “20, 30, 50 and 100,” the controller 130 may select a minimum amount (amount unit) of digital currency recommended to a corresponding user account, between 50 and 100, and the controller 130 may select the minimum amount unit, 50 as a recommendation amount. In this case, information on the recommendation amount may be output as the minimum amount 430 of FIG. 4.

Under this configuration, when an automatic payment is registered at the user account, an electronic payment process may be immediately started by controlling an amount of digital currency retained at the user account to satisfy a payment condition.

The controller 130 may control an amount unit which is less than the amount of digital currency retained at a user account, so that it is not included on a drop-down type of list.

A minimum amount unit recommended to a user account may be variously changed in a manner besides the aforementioned methods.

As another example, as shown in FIG. 5, based on a user's selection for a second payment type, the controller 130 may receive, from a user account, i) information 530 on a reference date (a specific date, a payment execution date, a payment date, etc.) corresponding to a payment process starting condition (or payment condition), and ii) information 540 on an amount of digital currency to be purchased through a payment process.

As shown in FIG. 5, when a graphic object 520 corresponding to a second payment type is selected from the user account and selection information is received, the controller 130 may provide, onto the user's electronic device 200, a page corresponding to a graphic user interface (GUI) for inputting a reference date 530 corresponding to a condition to start a payment process, and ii) an amount 540 of digital currency (e.g., cookies) to be purchased (or to be charged) on the reference date.

A user may input selection information for charging a predetermined number of units of digital currency on each reference date through a page. The selection information selected from the user's electronic device 200 may be transmitted to the digital currency payment system 100. For instance, if the user wishes to charge 100 cookies on the 1^{st} day of each month, the user may select a reference date (or a specific date) as the 1^{st} day, and may select a purchase amount of digital currency as 100. Such selection information may be transmitted to the digital currency payment system 100 of the present invention.

As shown in FIGS. 4 and 5, the controller 130 may provide a user with information 450, 550 related to inducement of registration of an automatic payment in order to induce an automatic payment registration more positively.

The information 450, 550 may include at least one of information on benefits of digital currency provided to the user, and information on benefits of contents usage, based on an automatic payment (i.e., automatic charging) of digital currency.

As aforementioned, in a case where selection information related to a payment condition is received from the user (the user account or the user's electronic device), the controller 130 may register a payment condition corresponding to a specific payment type to the user account, by using the selection information.

The controller 130 may register a different payment condition to a user account according to selection information. Here, “registration” may mean storage of selection information by being matched with a user account.

Meanwhile, information registered to a user account may include at least one of i) information on a payment type, ii) detailed information on a payment condition according to a payment type (e.g., a minimum amount of digital currency which allows a payment process to be started, information on a reference date when a payment process is started, etc.), and iii) information on an amount (or amount information) of digital currency purchased through a payment process. Information registered to a user account may be expressed as information related to a payment condition such as “information about a payment condition” or “payment condition information.”

The controller 130 registers a payment condition to a user account, and thus may control an electronic payment process for the user account to be started as a payment event which satisfies the payment condition at the user account. In the present invention, this will be referred to as “automatic payment registration (or automatic charging registration).”

Referring to FIG. 6(a), an example to register a payment condition for a first payment type will be explained. The controller 130 may register, to a user account, i) information on a payment type 613 (e.g., information on a first payment type) received from the user account, ii) information on a payment condition 611 (information on a minimum amount of digital currency which allows a payment process to be started, e.g., 30) and iii) information on a purchase amount 612 (information on a purchase amount of digital currency, e.g., 100). As shown, the registration information may be provided to the user's electronic device for the user's check.

Further, referring to FIG. 6(b), an example to register a payment condition for a second payment type will be explained. The controller 130 may register, to a user account, i) information on a payment type 623 (e.g., information on a second payment type) received from the user account, ii) information on a payment condition 621 (information on a reference date when a payment process is started, e.g., the 1^{st} day of the month) and iii) information on a purchase amount 622 (information on a purchase amount of digital currency, e.g., 100). As shown, the registration information may be provided to the user's electronic device 200 for the user to check.

After a payment condition is registered to the user account, a payment event related to the payment condition may be generated at the user account.

The controller 130 may monitor whether a payment event which satisfies the payment condition registered to the user account is generated at the user account.

Based on the payment condition according to the payment type registered to the user account, the controller 130 may continuously check an amount of digital currency retained at the user account, or may determine whether a current date is consistent with a reference date (specific date) registered to the user account.

More specifically, in a case where the payment condition registered to the user account is related to a first payment type, when an amount of digital currency retained at the user account is less than (or equal to or less than) a reference amount (or a minimum amount) corresponding to the payment condition, the controller 130 may determine that a payment event has occurred. In contrast, when an amount of digital currency retained at the user account is more than (or exceeds) a reference amount (or a minimum amount) corresponding to the payment condition, the controller 130 may determine that a payment event has not occurred.

Further, in a case where the payment condition registered to the user account is a payment condition related to a second payment type, when a current date is a pre-registered reference date, the controller 130 may determine that a payment event has occurred. In contrast, when a current date is not a pre-registered reference date, the controller 130 may determine that a payment event has not occurred.

In this manner, the controller 130 may monitor whether a payment event according to a pre-registered payment condition has occurred at the user account.

In a case where the occurrence of a payment event has been monitored at the user account, an electronic payment process for purchase of digital currency may be started (S320).

In a case where a payment event related to a preset payment condition has occurred at the user account as a monitoring result, the controller 130 may start an electronic payment process to purchase digital currency for the user account, in response to the occurrence of the payment event.

Here, the “start of an electronic payment process” may mean an action (behavior) or a procedure to begin an electronic payment process. That is, the start of an electronic payment process is a concept differentiated from “completion of an electronic payment process,” and may mean beginning of an electronic payment process. When an electronic payment process is started, an electronic payment process for purchasing digital currency by using a payment means registered to the user account may be performed. The completion of an electronic payment process may mean a completed state of purchase of digital currency.

In a case where an electronic payment process is started, the controller 130 may perform an electronic payment for purchase of a predetermined amount of digital currency included in a payment condition pre-registered to the user account.

In the present invention, an electronic payment process is performed in various manners, and a price for a purchase amount of digital currency may be paid by using a payment means pre-registered to the user account. For instance, when a pre-registered payment means is an account transfer or a credit card, the controller 130 may control the communication unit 110 to communicate with a financial institution (bank or credit card company) server. The controller 130 may control the communication unit 110 to request a financial institution to pay for a price corresponding to a specific purchase amount of digital currency, from a bank account or a credit card associated with the user account. However, the aforementioned procedure is a mere example, and a procedure firstly performed for an electronic payment process is not limited to this.

The price to be paid through an electronic payment process may correspond to amount information. Here, the amount information is information included in a payment condition pre-registered to a user account, and may be a price corresponding to a purchase amount of digital currency.

That is, in the present invention, a price to be paid may mean a price corresponding to a purchase amount of digital currency included in a payment condition pre-registered to the user account. The price to be paid may mean a price corresponding to an amount of digital currency to be charged by the user. In the present invention, a price to be paid may be used together with a payment object price.

In a case where a purchase of digital currency has been completed through an electronic payment process, the digital currency having been purchased may be supplied to the user account (S330).

“Completion of an electronic payment process” may mean a paid state of a price to the digital currency payment system 100 of the present invention through an electronic payment. A case where the price has been normally paid to the digital currency payment system 100 of the present invention will be referred to as “completion of an electronic payment process.”

When an electronic payment process is completed, the controller 130 may provide digital currency having a predetermined purchase amount to the user account.

The controller 130 may provide an amount corresponding to purchased digital currency to the user account. For instance, in a case where a purchase of 100 units of digital currency has been set to a payment condition, the controller 130 may start and complete an electronic payment process for a price corresponding to 100 units of digital currency, and may provide 100 units of digital currency to the user account.

The controller 130 may continuously monitor the occurrence of a payment event after an electronic payment for the user account has been completed. That is, the controller 130 may monitor the user account to which an automatic payment method has been registered, thereby starting a payment process whenever an event which satisfies a payment condition occurs at the user account.

The controller 130 may start an electronic payment process whenever a payment event occurs at the user account, according to a monitoring result. Thus, the user may be automatically provided with a purchase service of digital currency whenever a payment condition is satisfied.

Based on completion of an electronic payment process, the controller 130 may supply digital currency to the user account, and then monitor whether a next payment event has been generated. When a payment event occurs, the controller 130 may continuously monitor whether a payment event has been generated, instead of stopping monitoring.

Thus, the controller 130 may supply digital currency corresponding to amount information pre-registered to the user account whenever an electronic payment process is normally completed at the user account. That is, the controller 130 may provide digital currency to the user account whenever a payment event occurs and an electronic payment process is completed. In this specification, this will be referred to as “automatic payment (or automatic charging).”

For instance, when selection information about a received payment type (e.g., a first payment type), a payment condition (e.g., a minimum amount of 50) and amount information (e.g., purchase of 100 units of digital currency) are received from the user account, the controller 130 may start an electronic payment process for a price corresponding to 100 units of digital currency whenever the number of units of digital currency retained at the user account is less than 50 (e.g., 48). When the electronic payment process for the price corresponding to 100 units of digital currency is completed, the controller 130 may provide 100 units of digital currency to the user account.

As another example, when selection information about a received payment type (e.g., a second payment type), a payment condition (e.g., a reference date, the 1^{st} day) and amount information (e.g., purchase of 100 units of digital currency) are received from the user account, the controller 130 may start an electronic payment process for the price corresponding to 100 units of digital currency whenever a current date corresponds to the 1st day (e.g., the 1st day of February, the 1st day of March, etc.). When the electronic payment process for the price corresponding to 100 units of digital currency is completed, the controller 130 may provide 100 units of digital currency to the user account.

For instance, as shown in FIG. 7, in the case of receiving selection information on a payment type (e.g., a first payment type 711), a payment condition (e.g., less than 30, 712) and amount information (e.g., 30, 713), from a user account 710 having an ID “AAA,” the controller 130 may start an electronic payment process for a price corresponding to 30 units of digital currency whenever the number of units of digital currency retained at the user account 710 having an ID “AAA” is less than 30 (e.g., 28).

When the electronic payment process for a price corresponding to 30 units of digital currency is completed, the controller 130 may supply 30 units of digital currency to the user account. If such an automatic payment is firstly performed at the user account having an ID “AAA,” the number of times that the electronic payment process is completed at the user account having an ID “AAA” may be one (714).

As another example, in the case of receiving selection information on a payment type (e.g., a second payment type 721), a payment condition (e.g., a reference date, the 3rd day 722) and amount information (e.g., 100, 723), from a user account 720 having an ID “DDD”, the controller 130 may start an electronic payment process for a price corresponding to 100 units of digital currency whenever a current date corresponds to the 3rd day (e.g., February 3, March 3, etc.). When the electronic payment process for a price corresponding to 100 units of digital currency is completed, the controller 130 may supply 100 units of digital currency to the user account having an ID “DDD.” If the electronic payment is performed after a 39th electronic payment process has been completed at the user account having an ID “DDD,” the number of times that the electronic payment process is completed may be 40 (724).

So far, a method to automatically perform an electronic payment process according to a specific payment type, and a method to supply digital currency to a user account have been explained.

In the digital currency payment method and system 100 according to the present invention, “reward digital currency” may be supplied to the user account separately from digital currency supplied in correspondence to the user's payment for a price (hereinafter, will be referred to as “purchase digital currency”). The “reward digital currency” provided in the digital currency payment method and system according to the present invention will be explained in more detail. The reward digital currency according to the present invention may be used together with bonus digital currency.

The reward digital currency according to the present invention may have a plurality of attributes (properties) or types. Such attributes (properties) or types of the reward digital currency may be categorized according to a supply time of the reward digital currency to the user account, or a supply reason. i) “Reward digital currency of a first attribute” is digital currency supplied to the user account when the number of times (frequency) of completion of an electronic payment process is one (the first process), and may be used together with “first payment bonus” and “frequency bonus” in the present invention. ii) “Reward digital currency of a second attribute” is digital currency supplied to the user account whenever an electronic payment process is completed, and may be used together with “regular bonus” in the present invention. iii) “Reward digital currency of a third attribute” is digital currency supplied to the user account when the number of times (frequency) of completion of an electronic payment process satisfies a preset reward condition, and may be used together with “maintenance bonus” in the present invention.

Here, the preset reward condition may be that a completion frequency corresponds to a specific frequency or to a frequency (the number of times) repeated with a constant interval.

Firstly, reward digital currency having a first attribute will be explained.

When an electronic payment process is firstly completed (a first process), the controller 130 may supply reward digital currency of a first attribute to the user account. The controller 130 may further supply reward digital currency of a first attribute to the user account with a reward amount, in addition to a purchase amount of purchase digital currency. The controller 130 may provide a larger amount of reward digital currency of a first attribute to the user account when a purchase amount is larger.

In a case where a payment process is completed at the user account, the controller 130 may search the number of times that the payment process is completed at the user account. The controller 130 may perform the search from a payment history (or history information) corresponding to the user account.

The controller 130 may determine a reward amount of reward digital currency of a first attribute to be supplied to the user account, based on matching information stored in the storage unit 120.

As shown in FIG. 8, the matching information is information stored in a preset database (DB) of the storage unit 120, and may include information on a reward amount to be supplied to the user account. The matching information may include information on reward amounts respectively matched with different purchase amounts of digital currency. Further, the matching information may include amount information on reward currency of different attributes.

The matching information may include information on an amount of reward currency having each attribute, to be supplied to each purchase digital currency. The controller 130 may provide reward digital currency of a first attribute with a specific reward amount, to the user account, based on the matching information 800. For instance, according to the matching information 800 stored in the storage unit 120, a purchase amount of digital currency is 30 (820), and a reward amount of reward digital currency having a first attribute matched with the purchase amount is 2 (821). When a first payment process for 30 units of digital currency has been completed at the user account, the controller 130 may further provide 2 units of reward digital currency of a first attribute (821), in addition to the 30 units of purchased digital currency (820), to the user account.

As another example, according to the matching information 800 stored in the storage unit 120, a purchase amount of digital currency is 100 (830), and a reward amount of reward digital currency having a first attribute matched with the purchase amount is 5 (832). As shown in FIG. 9, when a first payment process for 100 units of digital currency has been completed at the user account, the controller 130 may further provide 5 units of reward digital currency of a first attribute (832), in addition to the 100 units of purchased digital currency (830), to the user account.

Although a first electronic payment process has been completed at the user account, the controller 130 may not supply reward digital currency of a first attribute to the user account, if there does not exist an amount of reward digital currency of a first attribute matched with a purchased amount of digital currency, as a check result of matching information. For instance, as shown, in a case where 20 units of digital currency have been purchased at the user account, there may not exist reward digital currency of a first attribute to be supplied to the user account.

Further, the controller 130 may supply “reward digital currency of a second attribute” to the user account, based on completion of an electronic payment process.

As aforementioned, reward digital currency of a second attribute is digital currency supplied whenever an electronic payment process is completed, and may be understood as “regular bonus” as mentioned earlier.

The controller 130 may further provide reward digital currency of a second attribute to the user account with a reward amount, in addition to a purchase amount of digital currency. As shown in FIG. 8, the controller 130 may provide a larger amount of reward digital currency of a second attribute to the user account when a purchase amount is larger.

Meanwhile, the controller 130 may provide reward digital currency of a second attribute to the user account only when a purchase amount of digital currency through an automatic payment method is a preset amount (e.g., when more than 100 units of digital currency are purchased in FIG. 8).

The controller 130 may determine a reward amount of reward digital currency having a second attribute to be supplied to the user account, based on matching information stored in the storage unit 120.

Although an electronic payment process has been completed, the controller 130 may not supply reward digital currency of a second attribute to the user account, if there does not exist an amount of reward digital currency of a second attribute matched with a purchased amount of digital currency, as a check result of matching information.

For instance, according to the matching information 800 stored in the storage unit 120, a purchase amount of digital currency is 30 (820), and a reward amount of reward digital currency having a second attribute matched with the purchase amount is 0 (822). Accordingly, in a case where an electronic payment process for 30 units of digital currency has been completed at the user account, the controller 130 may not provide reward digital currency of a second attribute.

As another example, according to the matching information 800 stored in the storage unit 120, a purchase amount of digital currency is 100 (830), and a reward amount of reward digital currency having a second attribute matched with the purchase amount is 2 (832). Accordingly, whenever an electronic payment process for 100 units of digital currency is completed at the user account, the controller 130 may provide 2 units of reward digital currency of a second attribute (832) to the user account.

Further, when a completion frequency of an electronic payment process satisfies a preset reward condition, the controller 130 may supply “reward digital currency of a third attribute” to the user account.

Here, the “reward digital currency of a third attribute” is digital currency supplied to the user account when the number of times (frequency) of completion of an electronic payment process satisfies a preset reward condition, and may be used together with “maintenance bonus” in the present invention. Here, the preset reward condition may be that a completion frequency corresponds to a specific frequency, or corresponds to a frequency (the number of times) repeated with a constant interval. For instance, the reward digital currency of a third attribute may be reward digital currency supplied when a completion frequency of an electronic payment process corresponds to every 10th completion (e.g., 10^{th}, 20^{th}, 30^{th} . . . ).

The controller 130 may provide a larger amount of reward digital currency of a third attribute to the user account when a purchase amount is larger. More specifically, the controller 130 may determine a reward amount of reward digital currency of a third attribute to be supplied to the user account, based on matching information stored in the storage unit 120.

As shown in FIG. 8, the matching information is information stored in a preset DB of the storage unit 120, and may mean information on reward amounts of reward digital currency of a third attribute respectively matched with different purchase amounts of digital currency.

The controller 130 may provide reward digital currency of a third attribute with a specific reward amount, to the user account, based on the matching information 800.

For instance, according to the matching information 800 stored in the storage unit 120, a purchase amount of digital currency is 30 (820), and a reward amount of reward digital currency having a third attribute matched with the purchase amount is 1 (823). Accordingly, when a completion frequency of an electronic payment process satisfies a preset condition (e.g., whenever an electronic payment process of the number of times corresponding to a multiple of 10 is completed), the controller 130 may further provide 1 reward digital currency of a third attribute (823) to the user account, in addition to the 30 units of purchased digital currency (820).

As another example, according to the matching information 800 stored in the storage unit 120, a purchase amount of digital currency is 100 (830), and a reward amount of reward digital currency having a third attribute matched with the purchase amount is 3 (833). Accordingly, as shown in FIG. 9, when a completion frequency of an electronic payment process satisfies a preset condition (e.g., whenever an electronic payment process of the number of times corresponding to a multiple of 10 is completed (834)), the controller 130 may further provide 3 units of reward digital currency of a third attribute (833) to the user account, in addition to the 100 units of purchased digital currency (830).

Although a completion frequency of an electronic payment process is a frequency at which reward digital currency of a third attribute should be supplied, the controller 130 may not supply reward digital currency of a third attribute to the user account, if there does not exist an amount of reward digital currency of a third attribute matched with a purchased amount of digital currency, as a check result of matching information.

For instance, according to the matching information 800 stored in the storage unit 120, a purchase amount of digital currency is 20, and a reward amount of reward digital currency having a third attribute matched with the purchase amount is 0. Accordingly, in a case where an electronic payment process for 20 units of digital currency has been completed at the user account, the controller 130 may not provide reward digital currency of a third attribute.

Thus, in a case where an electronic payment process for purchase of digital currency has been completed at the user account, the controller 130 may determine whether there exists reward digital currency to be additionally supplied to the user account, based on matching information.

The controller 130 may determine whether the user account having completed an electronic payment process satisfies a condition to receive reward digital currency corresponding to each of first to third attributes.

The controller 130 may determine whether a first purchase of digital currency has been performed at the user account, and may determine whether a purchase amount of digital currency satisfies a condition for supplying reward digital currency of a first attribute.

In a case where an electronic payment process for purchase of digital currency has been completed at the user account, the controller 130 may determine whether a purchase amount of digital currency satisfies a condition for supplying reward digital currency of a second attribute (e.g., a case where more than 100 units of digital currency have been purchased). If the purchase amount of digital currency satisfies the condition for supplying reward digital currency of a second attribute as a determination result, the controller 130 may supply reward digital currency of a second attribute to the user account. In a case where more than 100 units of digital currency have been purchased at the user account, reward digital currency of a second attribute may be supplied to the user account.

Further, the controller 130 may count a completion frequency of an electronic payment process for purchase of digital currency at the user account, and may determine whether the counted completion frequency is a specific completion frequency corresponding to a condition for supplying reward digital currency of a third attribute (e.g., 10th, 20th, etc.).

If the completion frequency corresponds to the specific completion frequency, the controller 130 may determine whether a purchase amount of digital currency satisfies a condition for supplying reward digital currency of a third attribute (e.g., a case where more than 30 units of digital currency have been purchased). If the purchase amount of digital currency satisfies the condition for supplying reward digital currency of a third attribute as a determination result, the controller 130 may supply reward digital currency of a third attribute to the user account. In a case where more than 30 units of digital currency have been purchased at the user account, reward digital currency of a third attribute may be supplied to the user account per the specific frequency.

In this manner, in the present invention, in a case where digital currency has been purchased at the user account, reward digital currency is supplied based on at least one of a purchase amount of digital currency, and a purchase frequency (a completion frequency of an electronic payment process). This may allow a user who purchases digital currency in an automatic payment manner, to be provided with continuous benefits.

As aforementioned, in the user account to which an automatic payment method has been registered, amount information on the number of units of digital currency to be purchased through an automatic payment method may be stored in a matching manner.

In a registered state of the amount information to the user account, when a request to change a purchase amount of digital currency is received from the user account, the controller 130 may change the amount information registered to the user account into new amount information. When a preset payment event occurs at the user account, the controller 130 may start an electronic payment process for a payment price corresponding to the changed purchase amount.

Also, in a case where the changed purchase amount corresponds to a condition for supplying the aforementioned reward digital currency of a second attribute, the controller 130 may supply reward digital currency of a second attribute to the user account, with an amount matched with the changed purchase amount.

Further, the controller 130 may complete an electronic payment process for a price corresponding to the changed purchase amount, and may accumulate a completion frequency counted before the amount information is changed. That is, the controller 130 may consecutively count a completion frequency stored in the storage unit 120, without initializing the completion frequency stored in the storage unit 120.

Further, when the completion frequency satisfies a preset reward condition, the controller 130 may supply digital currency with a reward amount matched with matching information in correspondence to the changed purchase amount (reward digital currency of a third attribute), as well as digital currency with the changed purchase amount, to the user account.

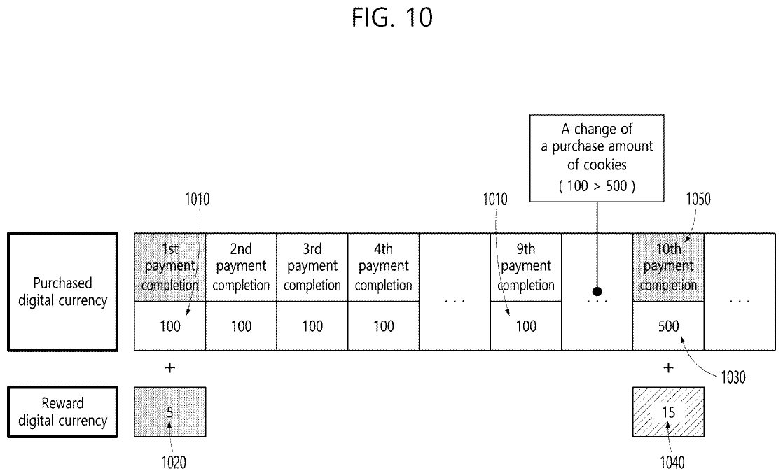

For instance, as shown in FIG. 10, in a case where an existing purchase amount of digital currency is 100 (1010) in relation to the user account, a preset reward condition may be that reward digital currency of a third attribute is supplied to the user account at every 10th process (e.g., whenever an electronic payment process of the number of times corresponding to a multiple of 10 is completed, 1050).

In this case, the controller 130 may complete a first electronic payment process for a price corresponding to a purchase amount of 100, and may supply 100 units of purchased digital currency 1010 and 5 units of reward digital currency 1020 (831 of FIG. 8) of a first attribute matched with the 100 units of purchased digital currency 1010, to the user account. Further, the controller 130 may complete 2nd to 9th electronic payment processes for a price corresponding to a purchase amount of 100, and may supply 100 units of purchased digital currency 1010 to the user account when each of the electronic payment processes is completed. Further, according to the matching information of FIG. 8, when each of the 2nd to 9th electronic payment processes is completed, 2 units of reward digital currency of a second attribute may be supplied to the user account.

After the 9th electronic payment process is completed, in a case where a request to change a purchase amount of digital currency is received from the user account, the controller 130 may change amount information pre-registered to the user account into 500 from 100. In this case, the controller 130 may perform an electronic payment process for purchase of the changed 500 units of digital currency 1030 based on the occurrence of a payment event, in relation to the user account. The controller 130 may update the completion frequency of an electronic payment process from 9th to 10th, and may determine whether the completion frequency satisfies a preset reward condition (10th payment, 1050). Here, because the completion frequency satisfies the preset reward condition (10th payment, 1050), the controller 130 may supply 500 units of purchased digital currency 1030 and reward digital currency 1040 (e.g., 15 units of reward digital currency, 843 of FIG. 8) of a third attribute matched with the changed 500 units of purchased digital currency 1030, to the user account.

In this manner, in a case where a payment condition or a purchase amount, etc. are changed in relation to the user account, the controller 130 may perform an electronic payment process based on the changed information, and may change to a proper amount of reward digital currency. In this case, when an electronic payment process performed at the user account is not a first process, a supply amount of digital currency related to at least one of second and third attributes may be changed.

According to one embodiment of the present invention, the controller 130 may differently set reward conditions according to a plurality of different payment types.

As aforementioned, a first payment type among a plurality of payment types may be a payment type to perform an automatic payment based on an amount of digital currency retained at the user account, and a second payment type may be a payment type to perform an automatic payment based on a reference date (a specific date). The controller 130 may set a reward condition in a manner to positively induce a user's automatic payment through maintaining of a viewing right to contents retained at the user account, by reflecting attributes of a plurality of different payment types and a user's consumption pattern. The controller 130 may set a frequency interval of a reward condition corresponding to the first payment type, to be different from a frequency interval of a reward condition corresponding to the second payment type.

More specifically, i) the controller 130 may set a frequency interval of a reward condition corresponding to the first payment type, to be relatively greater than a frequency interval of a reward condition corresponding to the second payment type. ii) Alternatively, the controller 130 may set a frequency interval of a reward condition corresponding to the first payment type, to be relatively smaller than a frequency interval of a reward condition corresponding to the second payment type.

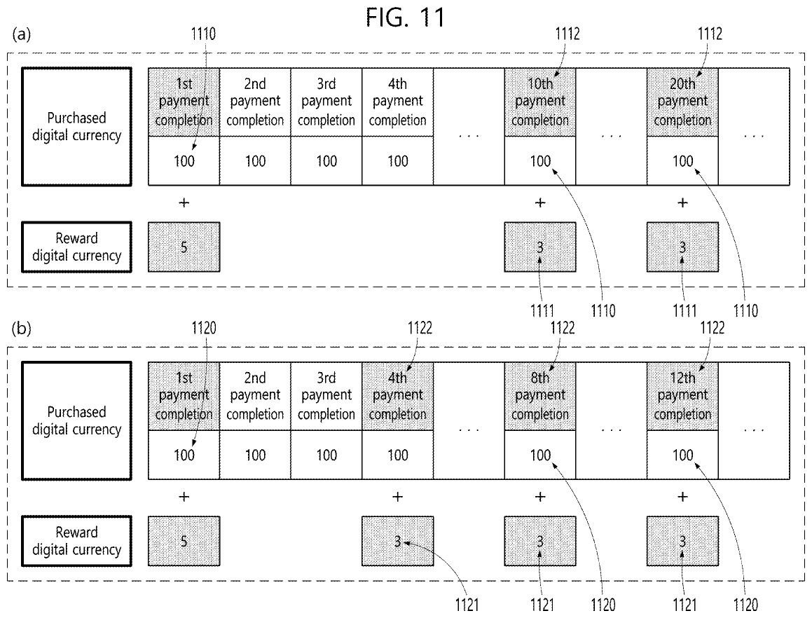

For instance, as shown in FIG. 11(a), the controller 130 may set a frequency interval of a reward condition corresponding to the first payment type as 10 (that is, whenever an electronic payment process of the number of times corresponding to a multiple of 10 is completed). In relation to the first payment type, the controller 130 may provide 3 units of reward digital currency (1111) of a third attribute corresponding to a purchase amount (100) of digital currency (1110) to the user account whenever a completion frequency is a multiple of 10 (i.e., 10, 20, 30 . . . (1112)).

As another example, as shown in FIG. 11(b), the controller 130 may set a frequency interval of a reward condition corresponding to the second payment type as 4 (that is, whenever an electronic payment process of the number of times corresponding to a multiple of 4 is completed). In relation to the second payment type, the controller 130 may provide 3 units of reward digital currency (1121) of a third attribute corresponding to a purchase amount (100) of digital currency (1120) to the user account whenever a completion frequency is a multiple of 4 (i.e., 4, 8, 12 . . . (1122).

In this manner, the controller 130 may differently set an interval of reward digital currency provision based on a payment event, although the same amount of digital currency is purchased.

So far, purchase digital currency and reward digital currency each being supplied to the user account based on completion of an electronic payment process has been explained. Hereinafter, a payment history stored in the storage unit 120 in association with the user account will be explained in more detail with reference to the attached drawings. FIG. 12 is a conceptual view for explaining a payment history of a user account according to the present invention.

The controller 130 may store a user's payment history in the storage unit 120 by associating with a user account. The payment history may mean information related to purchase of digital currency. For instance, the payment history may include at least one of information on i) a payment method for digital currency (e.g., a first payment method (a one-time payment method) or a second payment method (an automatic payment method), ii) in the case of the second payment method, whether a first payment type (a payment type performed on the basis of a holding amount of digital currency) or a second payment type (a payment type performed on the basis of a reference date), iii) an amount of digital currency purchased at a user account (accumulated purchase amount), iv) a purchase amount of digital currency purchased whenever a payment event occurs, v) an amount of digital currency owned at present, vi) an amount of reward digital currency supplied (accumulated supply amount), vii) an attribute of reward digital currency (which one of first to third attributes), viii) an available period of reward digital currency, ix) an amount of reward digital currency owned at present, x) purchase cancellation of digital currency, xi) change of a payment method, a payment type, etc., and xii) an automatic payment stop, release, etc.

Such payment history information may be provided to a user. As shown in FIG. 12, the controller 130 may provide at least a part of information included in the aforementioned payment history, onto the user's electronic device 200. As shown in FIG. 12, the controller 130 may provide a payment history 1220 related to digital currency, onto a payment history page 1210. Through the payment history page 1210, a user may be provided with i) the number of digital currency owned at present (1221), ii) a purchase (or charging) date of digital currency (1222), iii) the number of purchase (or charging) of digital currency (1223), iv) a price to be paid (1224), v) whether purchase of digital currency has been canceled (1225), etc.

Although not shown, the controller 130 may expose a digital currency purchase cancellation (refund request) button to the “payment history page” together with a payment history.

The controller 130 may expose a purchase cancellation (refund request) button only with respect to digital currency having its purchase cancellation available. That is, whether cancellation is allowable or unallowable may be differently set according to a lapse period on the basis of a purchase date of digital currency or according to a used state or a non-used state.

For instance, the controller 130 may not expose a purchase cancellation (refund request) button when i) a preset time period (e.g., 7 days) has lapsed on the basis of a purchase date of digital currency, and ii) when digital currency has been used (that is, consumed in contents viewing) although a preset time period (e.g., 7 days) has not lapsed on the basis of a purchase date of the digital currency.

If the purchase cancellation (refund request) button exposed onto the electronic device 200 is selected by a user, a purchase cancellation request (a refund request) for digital currency may be transmitted to the digital currency payment system 100 of the present invention.

In the case of receiving the refund request for digital currency having been purchased, the controller 130 may start a refund process for refunding a payment price corresponding to the digital currency having been purchased.

In the case of performing a refund process for digital currency having been purchased, the controller 130 may determine whether there exists reward currency supplied to the user account in correspondence to purchase of digital currency. In the case of performing a refund process for purchased digital currency, the controller 130 may withdraw supplied reward currency.

More specifically, the controller 130 may check whether there exist “digital currency corresponding to an already-supplied reward amount” in the user account. Here, the digital currency corresponding to an already-supplied reward amount may mean reward digital currency supplied to the user account based on digital currency having been purchased.

If there exist digital currency corresponding to an already-supplied reward amount in the user account as a check result, the controller 130 may withdraw the digital currency corresponding to an already-supplied reward amount from the user account, based on completion of a refund of a payment price.

Further, the controller 130 may check whether there exist “digital currency corresponding to a total sum of a purchase amount having been refund-requested and an already-supplied reward amount,” in the user account. Here, the already-supplied reward amount may mean a reward amount supplied based on digital currency which is an object of a refund request.

If there exists digital currency corresponding to a total sum of a purchase amount having been refund-requested and an already-supplied reward amount in the user account as a check result, the controller 130 may withdraw the digital currency corresponding to a total sum of a purchase amount having been refund-requested and an already-supplied reward amount, from the user account, based on completion of a refund of a payment price. In this case, the controller 130 may refund the payment price to the user through a payment means by which digital currency has been purchased, or through a preset means.

For instance, as shown in FIG. 13(a), a payment history page 1300 having a history 1310 where 100 units of purchase digital currency (e.g., 100 cookies) and 10 units of reward digital currency (e.g., 10 cookies) have been supplied to the user account will be explained.

The controller 130 may perform a refund process when i) there exists digital currency corresponding to an already-supplied reward amount (e.g., 10 cookies) in the user account, or when ii) there exists digital currency corresponding to a total sum of a purchase amount having been refund-requested (e.g., 100 cookies) and an already-supplied reward amount (e.g., 10 cookies) in the user account. The controller 130 may withdraw i) digital currency corresponding to an already-supplied reward amount (e.g., 10 cookies), or ii) digital currency (e.g., 110 cookies) corresponding to a total sum of a purchase amount having been refund-requested (e.g., 100 cookies) and an already-supplied reward amount (e.g., 10 cookies), from the user account, based on completion of a refund process. FIG. 13(b) shows a payment history page 1300 having output a history 1320 that digital currency (e.g., 110 cookies) corresponding to a total sum of a purchase amount having been refund-requested (e.g., 100 cookies) and an already-supplied reward amount (e.g., 10 cookies) have been withdrawn. As shown in FIG. 13(b), when the refund process is completed, the controller 130 may provide information on the completion to the user.

Further, if there does not exist “digital currency corresponding to a total sum of a purchase amount having been refund-requested and an already-supplied reward amount” in the user account, the controller 130 may specify a price obtained by excluding a price corresponding to a consumption amount of digital currency from a payment price, as a refund price. The controller 130 may perform a refund process with respect to the specified refund price, and may withdraw all of digital currency retained at the user account.

For instance, it is assumed that a user has purchased 100 units of digital currency with 10,000 won, and has been provided with 10 units of reward digital currency as compensation. A value of one digital currency is 100 won. In a situation where the user had consumed 10 units of digital currency and owns 100 units of digital currency at present, the user has requested to refund 100 units of purchase digital currency. The controller 130 may check that there does not exist digital currency corresponding to a total sum (110) of a purchase amount having been refund-requested (100) and an already-supplied reward amount (10) in the user account. In this case, the controller 130 determines that 10 units of digital currency have been consumed. The controller 130 specifies 9,000 won obtained by excluding 1,000 won (10×100 won) corresponding to 10 units of consumed digital currency from a payment price (10,000 won), as a refund price, and performs a refund process with respect to 9,000 won. If the user gets a refund of 9,000 won, the controller 130 withdraws all of 100 units of digital currency retained at the user.

In a case where a specified refund price is less than 0 won, the controller 130 may not perform a refund process. That is, in this case, a refund process may be impossible because a price (money) to be refunded does not exist. In this case, although there exists reward digital currency, it may not be counted as digital currency corresponding to a price to be refunded. For instance, it is assumed that 10 units of digital currency remain at present, in a state where 100 units of digital currency have been purchased and 10 units of reward digital currency have been supplied as compensation. In this state, if a refund request is received from the user account, the controller 130 may determine that the 100 units of purchased digital currency have been used up. That is, in this case, the controller 130 may consider the 10 units of digital currency retained (owned) at the user account as reward digital currency, and may determine that a refund process of digital currency is impossible.

Thus, in a case where a refund process request is received from the user account, the controller 130 may withdraw all of digital currency retained at the user account, and may not pay a refund price to the user account.

According to an embodiment of the present invention, the controller 130 may set an available period (usage period) of purchase digital currency to be different from that of bonus digital currency. In the case of purchase digital currency, an available period may not be set. In the case of bonus digital currency, an available period may be set for the bonus digital currency to be usable only for a specific period of time.

Alternatively, in the case of purchase digital currency, an available period may be set. In this case, the controller 130 may set an available period of bonus digital currency to be relatively shorter than that of purchase digital currency.

Further, in the case of digital currency having a setting of an available period, the controller 130 may set a starting date of the available period as a date when digital currency has been supplied to a user account.

For instance, as shown in FIG. 14, a user account, “CCC” 1410 has a total of 14 units of bonus digital currency 1420. The 14 units of bonus digital currency of the “CCC” user account (user ID) consist of i) 8 units of bonus digital currency 1421 supplied on Jan. 1, 2021, ii) 3 units of bonus digital currency 1422 supplied on Mar. 5, 2021, and iii) 3 units of bonus digital currency 1423 supplied on Apr. 7, 2021. Each units of the bonus digital currency has an available period of 6 months. Thus, an expiration date of each units of the bonus digital currency retained by the “CCC” user account may be differently set. That is, in the case of i) 8 units of bonus digital currency 1421 being supplied on Jan. 1, 2021, an expiration date may be Jul. 1, 2021. In the case of ii) 3 units of bonus digital currency 1422 being supplied on Mar. 5, 2021, an expiration date may be Sep. 5, 2021, and in the case of iii) 3 units of bonus digital currency 1423 being supplied on Apr. 7, 2021, an expiration date may be Oct. 7, 2021.

When a set available period of digital currency lapses, the controller 130 may control the digital currency having its available period lapsed to expire. In this case, the expired digital currency supplied to a user account may be withdrawn or subtracted from the user account.

Here, the controller 130 may inform the user account of an expiration schedule of the digital currency, before the expiration date of each digital currency by a preset time period. The controller 130 may set an available period according to each attribute of reward digital currency.

In a case where there exist a plurality of units of reward digital currency having different available periods at the user account, the controller 130 may control usage of the reward digital currency such that the reward digital currency are used according to the order that the available periods are firstly expired.

Although a type of reward digital currency to be used is not selected from the user account, the controller 130 itself may control the reward digital currency to be used according to the order that the available periods are firstly expired.

According to an embodiment of the present invention, the controller 130 may store user history information associated with the user's electronic device 200 in the storage unit 120.

The history information may include various information on purchase of digital currency at the user account. The history information may include the aforementioned payment history information.

In relation to the user account, the history information may include at least one of i) a payment number of an electronic payment process for purchase of digital currency, ii) a payment date (a date when an electronic payment process has been completed), iii) a purchase amount and a reward amount of digital currency, iv) a remaining amount of digital currency retained at the user account (a remaining amount of purchased digital currency, and a remaining amount of reward digital currency), v) a state of digital currency (one of a state in which digital currency supplied to the user account have not been used (an issued state), a state in which some units of digital currency supplied to the user account have been used in contents viewing (a state of being used), and a state in which all of digital currency supplied to the user account have been used up (a totally exhausted state)), vi) a payment method for purchase of digital currency (for example, a first payment method or a second payment method), vii) a payment price, viii) a refund price, ix) a usage history of digital currency, x) a registration or a change history of a second payment method, xi) a provision history of reward digital currency, xii) an attribute of reward digital currency (one of first to third attributes of reward digital currency), and xiii) an available period of reward digital currency.

As shown in FIG. 15, the controller 130 may store i) a purchase amount of purchase digital currency (1511), and ii) a reward amount of reward digital currency (1512), in the storage unit 120 as user history information, in an associating manner with the user account.

Further, as shown in FIG. 15, the controller 130 may store i) a remaining amount of purchase digital currency (1521), and ii) a remaining amount of reward digital currency (1522), in the storage unit 120 as user history information, in an associating manner with the user account.

The controller 130 may specify a refund price and an amount of digital currency to be withdrawn from the user account, based on i) a purchase amount of digital currency (1511), ii) a reward amount of reward digital currency (1512), iii) a remaining amount of digital currency (1521), and iv) a remaining amount of reward digital currency (1522). The controller 130 may perform the aforementioned refund process based on such amount information. Explanations about the refund process will be replaced by the aforementioned descriptions.

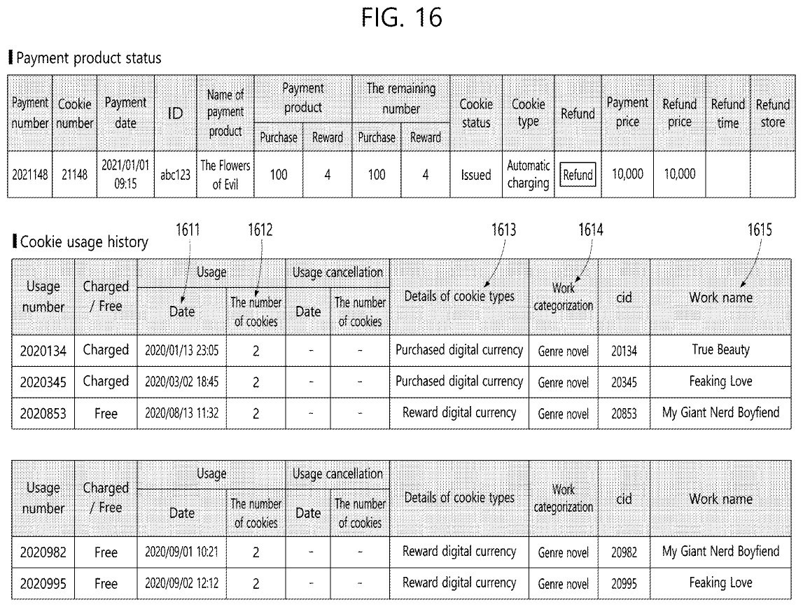

As shown in FIG. 16, the controller 130 may store i) a date (1611) when contents have been viewed at the user account by using digital currency, ii) an amount of digital currency (1612) which have been used in contents viewing, iii) a type of digital currency which has been used in contents viewing (e.g., at least one of purchased digital currency and reward digital currency, 1613), iv) a contents type (e.g., a genre of a contents work 1614), v) a contents name (e.g., a work name 1615), etc. in the storage unit 120 as user history information, in an associating manner with the user account.

Further, the history information may include various information associated with the user account, and may be processed in an associated manner with information on the aforementioned various situations.

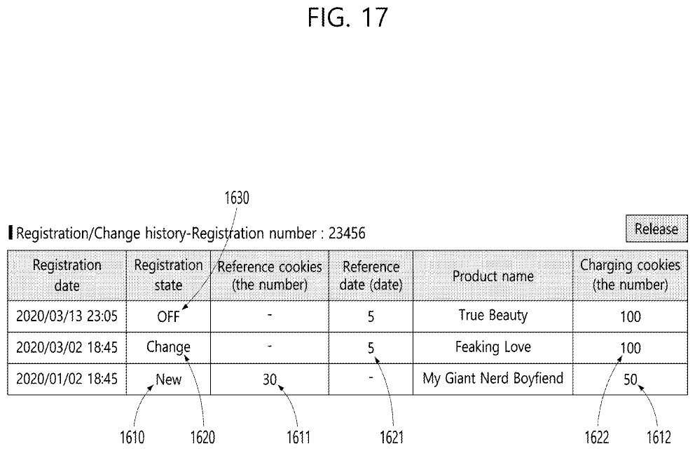

For instance, as aforementioned, if selection information is received from the user account in relation to a registration or a change history of a second payment method, the controller 130 may store a registration state of the user account (e.g., New 1610), a payment condition (e.g., a minimum amount of 30, 1611) and amount information (e.g., 50, 1612) in the storage unit 120 in an associating manner with each other, as shown in FIG. 17.

Further, in a case that a change request for a payment condition or a change request for a purchase amount of digital currency is received from the user account, the controller 130 may store a registration state of the user account (e.g., Change 1620), a payment condition (e.g., a reference date of the 5th day, 1621) and amount information (e.g., 100, 1622) in the storage unit 120 in an associating manner with each other, based on the change request information.

Further, in a case where an automatic payment stop request is received from the user account, the controller 130 may store an automatic payment registration state of the user account (e.g., OFF 1630) and amount information before stop (e.g., 100) in the storage unit 120 in an associating manner with each other.

The present invention may provide an automatic payment interruption (stop) function and a release function, and information on the functions may be stored in user history information. In the present invention, the interruption means a temporary pause of an automatic payment (or automatic charging) function, and may be differentiated from a release to erase (or cancel) an automatic payment (or automatic charging) registered to a user account.

In the present invention, an automatic payment interruption (stop) function is temporarily stopping an automatic payment operation, which may mean converting an automatic payment function from an active state into an inactive state. The controller 130 may prevent an automatic payment for purchase of digital currency from being performed at a user account, while an automatic payment function is in an inactive state. In this case, although a payment event which satisfies an automatic payment condition occurs at the user account, an automatic payment may not be performed.

In a case where an automatic payment (or automatic charging) function registered to the user account is in an active state, the controller 130 may receive information which changes the automatic payment (or automatic charging) function into an inactive state, from the electronic device 200 (i.e., automatic payment interruption).

Further, in a case where an automatic payment (or automatic charging) function registered to the user account is in an inactive state, the controller 130 may receive information which changes the automatic payment (or automatic charging) function into an active state, from the electronic device 200 (i.e., automatic payment interruption release).

When a request to stop an automatic payment function (i.e., a request to stop an automatic payment or to release an automatic charging) is received from the user account, the controller 130 may store, in the storage unit 120, information on a payment history including the number of times of an electronic payment process which has been completed at the user account, and information on the request to stop an automatic payment function.

The controller 130 may not start a payment process for purchase of digital currency, even if a payment event which satisfies a payment condition registered to the user account occurs in relation to the user account. Especially, the controller 130 may not start a payment process for purchase of digital currency even if a payment event occurs, for a preset time period from a time when a request to stop a purchase function is received from the user account.

The controller 130 may release the stop of a purchase function at the user account, after a preset time period from the time when the request to stop a purchase function is received from the user account. That is, when a preset time period lapses, the controller 130 may change the automatic payment (or automatic charging) function of the user account into an active state. In this case, the controller 130 may re-monitor whether a payment event which satisfies a payment condition registered to the user account occurs, and may start an electronic payment process when a payment event occurs.

Here, the preset time period may be selected from the user, or may be set by the controller 130. When the preset time period is selected from the user, the controller 130 may restrict the preset time period from exceeding a predetermined time period. That is, when the preset time period selected from the user exceeds a predetermined time period, the controller 130 may stop a purchase function only for the predetermined time period.

Further, the controller 130 may not start an electronic payment process at the user account for a preset time period (e.g., 90 days) from a time when a request to stop a purchase function is received.

After the preset time period (e.g., 90 days) from the time when the request to stop a purchase function is received, the controller 130 may output a message for checking whether to activate an automatic payment (or automatic charging) function onto the electronic device 200.

Further, the controller 130 may activate an automatic payment (or automatic charging) function, and may monitor whether a payment event occurs at the user account.

In a case where an electronic payment process by an automatic payment is completed after an automatic payment function is converted into an active state from an inactive state, the controller 130 may count a frequency (the number of times) in a subsequent manner (i.e., continuously) to a payment completion frequency counted before the automatic payment function became inactive.

For instance, in a case where an electronic payment process by an automatic payment is completed as an automatic payment function is converted into an active state from an inactive state, in a state that a payment completion frequency counted before the automatic payment function become inactive is 9, the controller 130 may count the number of times of the electronic payment as 10.

According to one embodiment, the present invention may provide a function to release an automatic payment (or automatic charging).

In the present invention, release means erasure of an automatic payment (or automatic charging) registered to a user account, and may be differentiated from interruption to temporarily stop an automatic payment (or automatic charging).

The controller 130 may provide a page for providing an automatic payment release function (hereinafter, will be referred to as “release page”) to the electronic device 200. The controller 130 may expose information related to the user account onto the release page. The information related to a user account may include information on user's benefits already provided due to an automatic payment function. As shown, the benefit information may include information on at least one of bonus digital currency already supplied to a user account, bonus digital currency which can be supplied when the user account maintains an automatic payment (or automatic charging) function, and a free usage right for contents.

The controller 130 may provide a graphic object for selecting activation or inactivation of an automatic payment (automatic charging) function onto one region of the “release page.” Under this configuration, the payment system 100 of the present invention may induce a user to select interruption of an automatic payment (automatic charging), not release of an automatic payment (automatic charging).

When a graphic object for releasing positioned on one region of the “release page” is selected by a user, release request information may be transmitted to the electronic payment system 100 of the present invention.

When a release request is received from the electronic device 200, the controller 130 may provide information associated with the user account (e.g., benefit information) to the electronic device 200. Under this configuration, the payment system 100 of the present invention may induce a user to maintain an automatic payment (or automatic charging) function, by re-informing benefit information to the user.

For instance, a user may be provided with benefits associated with the user account through the “release page.” Through the release page, a user may be provided with benefit information such as an amount of digital currency (e.g., 10 cookies) already supplied through an automatic payment (automatic charging) registration, or an amount of digital currency (e.g., 10 cookies) supplied whenever an automatic payment (automatic charging) is performed.

When a user selects the release function icon on the release page, benefits associated with the user account may be provided onto the electronic device 200 in the form of a pop-up message. For instance, information for preventing a user from releasing an automatic payment (automatic charging), such as “In case of release, you cannot receive any longer 25 bonus cookies provided at the time of every 10th payment despite re-registration” may be provided in the form of a pop-up message.

In a case where a user releases an automatic payment (automatic charging) function despite benefits which can be provided while the automatic payment (automatic charging) is maintained, a page for selecting the release may be provided onto the electronic device 200.

In a case where the user requests for an automatic payment registration after the automatic payment is released, the controller 130 may count the number of times in a subsequent manner (i.e., continuously) to a payment completion frequency (the number of times) counted before the automatic payment function was released.

For instance, in a case where an electronic payment process is completed as an automatic payment function is requested again, in a state in which a payment completion frequency counted before the automatic payment function is released is 9, the controller 130 may count the number of times of the electronic payment as 10.

In a case where the user requests for an automatic payment registration after the automatic payment is released, the controller 130 may newly count a completion frequency of an electronic process by an automatic payment function, from one. In this case, the user may be a re-registrant, and the controller 130 may supply bonus digital currency for celebrating rejoining, etc. to the user account corresponding to the re-registrant. In this case, user information may be updated to user history information as “a rejoined customer,” etc.

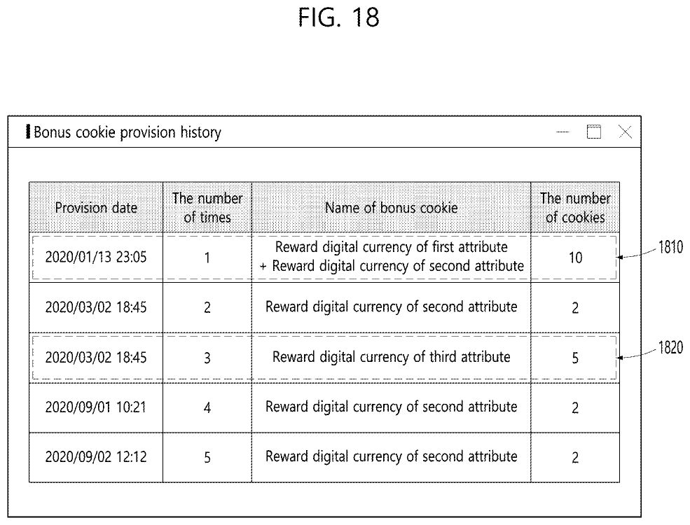

Further, the controller 130 may store a provision history of reward digital currency in the storage unit 120. For instance, as shown in FIG. 18, the controller 130 may store, in the storage unit 120, a provision history of reward digital currency (a provision date, e.g., Jan. 13, 2020) supplied to the user account, a type of reward digital currency (e.g., reward digital currency of a first attribute and reward digital currency of a second attribute), and a reward amount (e.g., 10, 1810) based on i) completion of a first electronic payment process. As another example, the controller 130 may store, in the storage unit 120, a provision history of reward digital currency (a provision date, e.g., Mar. 2, 2020) supplied to the user account, a type of reward digital currency (e.g., reward digital currency of a third attribute), and a reward amount (e.g., 5, 1820) based on ii) completion of an electronic payment process.

In this manner, the controller 130 may provide information on a provision history of reward digital currency, such as an attribute type of reward digital currency supplied to the user account, a provision amount and an available period, as user history information.

In the present invention, user history information related to purchase of digital currency and provision of reward digital currency is continuously updated. This may allow each user to be managed and monitored systematically.

As aforementioned, in the digital currency payment method and system of the present invention, whenever a payment event related to payment of digital currency occurs, a payment for purchase of digital currency is started. This may allow a payment for digital currency to be continuously performed. As a result, as purchase of digital currency used in contents viewing is continuously performed, consumption of contents may be continuously performed.

Further, at the time of viewing contents, a user's convenience that he or she need not perform an electronic payment for purchase of digital currency every time may be enhanced, and the user may freely view contents by using digital currency owned at any time.

That is, in the digital currency payment method and system of the present invention, an electronic payment process is automatically started based on the occurrence of a payment event related to a payment condition. This may provide a user's convenience that he or she need not additionally perform an electronic payment. Further, through a payment method for digital currency which allows contents viewing to be continuously performed, a contents provider may effectively induce contents consumption by a consumer and may ensure the consumer's continuous contents consumption. This may prevent the consumer from leaving.

Further, in the present invention, an amount of digital currency is differently supplied to the user account according to a completion frequency of an electronic payment process for purchase of digital currency. This may allow a user to be provided with rewards for purchase of digital currency, and to consume contents economically. A contents provider may prevent a user from halfway cancelling an automatic payment, thereby effectively managing members.

The aforementioned present invention may be executed by one or more processes in a computer, and may be implemented as a program which can be stored in a computer-readable medium.

Further, the aforementioned present invention can be implemented as a computer-readable code or instruction recorded in a recording medium. That is, the present invention may be provided in the form of a program.

The computer-readable medium includes all types of recording devices for storing data which can be read by a computer system. Examples of the computer-readable medium include a Hard Disk Drive (HDD), a Solid State Disk (SSD), a Silicon Disk Drive (SDD), ROM, RAM, CD-ROM, a magnetic tape, a floppy disk, an optical data storage device, etc.

Further, the computer-readable medium includes a storage unit which may be a server or a cloud storage unit to which an electronic device can access through communications. In this case, the computer may download a program of the present invention from the server or the cloud storage unit, through wired or wireless communications.

Further, in the present invention, the aforementioned computer is an electronic device where a processor, i.e., a Central Processing Unit (CPU) is mounted, and there is no limitation on a type of the computer.

The foregoing embodiments are merely exemplary and are not to be construed as limiting the present invention. The scope of the present invention should be determined by reasonable interpretations of the appended claims, and all changes and modifications that fall within the metes and bounds of the claims, or equivalents of such metes and bounds are therefore intended to be embraced by the appended claims.

1. A digital currency payment method, performed by a processor, for performing a payment related to digital currency used in contents viewing, the method comprising:
monitoring occurrence of a payment event related to a preset payment condition for purchase of the digital currency, in relation to a user account;
starting an electronic payment process for purchase of the digital currency with respect to the user account when the payment event has occurred at the user account as a monitoring result; and
supplying the digital currency to the user account when the purchase of the digital currency has been completed through the electronic payment process,
wherein an amount of the digital currency supplied to the user account is changed according to a completion frequency of the electronic payment process.

2. The method of claim 1, further comprising counting a completion frequency of the electronic payment process based on completion of the electronic payment process,
wherein the completion frequency of the electronic payment process is accumulated when the electronic payment process for purchase of the digital currency is completed at the user account.

3. The method of claim 2, wherein in the supplying of the digital currency, the digital currency is supplied to the user account with a different amount, based on whether the completion frequency of the electronic payment process satisfies a preset reward condition.

4. The method of claim 3, wherein in the supplying of the digital currency, when the completion frequency of the electronic payment process satisfies the preset reward condition, a purchase amount of the digital currency corresponding to a payment price of the electronic payment process, and a reward amount of the digital currency corresponding to a reward are supplied to the user account.

5. The method of claim 4, wherein the purchase amount of the digital currency and the reward amount of the digital currency with have available periods for viewing the contents set differently from each other.

6. The method of claim 5, wherein the available period for viewing the contents with the reward amount of the digital currency is set as a period after a preset time duration on the basis of a reference date when the supply of the reward amount of the digital currency has occurred.

7. The method of claim 4, wherein in the supplying of the digital currency, the electronic payment process is started when the payment event which satisfies the preset payment condition occurs at the user account, as a result of the monitoring.

8. The method of claim 7, wherein in the supplying of the digital currency, when the payment event occurs, an additional reward amount of the digital currency is supplied to the user account, in addition to the purchase amount of the digital currency.

9. The method of claim 4, wherein the reward amount of the digital currency is changed according to the purchase amount of the digital currency purchased in correspondence to the payment price, and
wherein matching information on reward amount of the digital currency respectively matched with the purchase amount of the digital currency is stored in a preset database (DB).

10. The method of claim 9, further comprising,
in a case where a change request for the purchase amount of the digital currency is received from the user account, registering purchase request information on a changed purchase amount corresponding to the change request, to the user account,
wherein in the supplying of the digital currency, when the completion frequency of the electronic payment process based on the payment event generated at the user account satisfies the preset reward condition, after the purchase request information has been registered, a purchase amount of the digital currency and a reward amount of the digital currency matched with the changed purchase amount are supplied, and
wherein the reward amount matched with the changed purchase amount is specified based on the matching information.

11. The method of claim 4, further comprising starting a refund process for refunding the payment price corresponding to the purchase amount of the digital currency, in a case where a refund request for the purchase amount of the digital currency is received from the user account,
wherein in the refund process, a check is made to determine whether there exists the reward amount of the digital currency already supplied at the user account, based on the digital currency having been purchased, and
wherein when there exists an already-supplied reward amount of the digital currency as a check result, the already-supplied reward amount of the digital currency is withdrawn from the user account, based on completion of a refund of the payment price.

12. The method of claim 1, wherein the preset payment condition is set in relation to an amount of digital currency already retained at the user account, and
wherein the payment event occurs when the amount of digital currency retained at the user account is less than a predetermined reference amount.

13. The method of claim 12, wherein reference amount information on the predetermined reference amount and purchase amount information on a purchase amount of the digital currency are stored in the user account in a matching manner,
wherein in the supplying of the digital currency, when the payment event occurs, the electronic payment process is performed such that the digital currency is purchased with a purchase amount corresponding to the purchase amount information stored in the user account in a matching manner.

14. The method of claim 1, wherein the contents consist of at least one episode, and
wherein each of the at least one episode has one of a charged product type which can be viewed through a payment of the digital currency, and a free product type which can be viewed without a payment of the digital currency.

15. The method of claim 14, wherein a product type of a specific episode having the charged product type, among the at least one episode is converted into a free product type based on lapse of a preset time.

16. A digital currency payment system for payment of digital currency used in contents viewing, the system comprising:
a storage unit configured to store user information related to a user account; and
a controller configured to monitor occurrence of a payment event related to a preset payment condition for purchase of the digital currency, in relation to the user account,
wherein the controller starts an electronic payment process for purchase of the digital currency with respect to the user account, based on the user information, when the payment event has occurred at the user account as a monitoring result,
wherein the controller supplies the digital currency to the user account when purchase of the digital currency has been completed through the electronic payment process, and
wherein an amount of the digital currency supplied to the user account is changed according to a completion frequency of the electronic payment process.

17. A non-transitory computer-readable recording medium storing a program for payment of digital currency used in contents viewing, the program causing a computer to perform the steps comprising:
monitoring occurrence of a payment event related to a preset payment condition for purchase of digital currency, in relation to a user account;
starting an electronic payment process for purchase of the digital currency with respect to the user account, in a case that the payment event has occurred at the user account as a monitoring result; and
supplying the digital currency to the user account when purchase of the digital currency has been completed through the electronic payment process,
wherein an amount of the digital currency supplied to the user account is changed according to a completion frequency of the electronic payment process.
